(19) United States
(12) Patent Application Publication
(10) Pub. No.: US 2019/0368464 A1
(43) Pub. Date: Dec. 5, 2019

(54) Submerged Water Column Power Generation System

(71) Applicant: Stephen Eric Knotts, Bellevue, WA (US)

(72) Inventor: Stephen Eric Knotts, Bellevue, WA (US)

(73) Assignee: Stephen Eric Knotts, Bellevue, WA (US)

(21) Appl. No.: 15/996,473

(22) Filed: Jun. 2, 2018

(51) Int. Cl. F03B 17/06; F03B 13/10; H02K 7/18; H02K 44/08

(52) U.S. Cl. CPC F03B 17/061; F03B 13/10; F03B 11/08; H02K 44/085; H02K 7/1823

(57) ABSTRACT

Disclosed is a submerged power generation system. The system may include a hollow fluid flow column, substantially parallel with the direction of gravitational acceleration, a fluid inlet, and a fluid power generator in the hollow fluid column. The system may further include fluid outlets and a pump system at the end of the fluid column opposite from the inlet. Further, an electrical distribution cable or power distribution system in communication with said fluid power generator may also be integrated into the system. Various other power storage, generation, and distribution systems may be integrated into the system to further enhance the efficiency and capabilities of the hydroelectric power generation system.

### BACKGROUND AND SUMMARY

The present invention relates generally to power generation systems, and more particularly to hydroelectric power generation technologies. The field that this new technology is associated with is the various electric power industries. The submerged water column generator technology can produce substantial levels of electricity, plus it advances new green technologies.

Currently, around the world, there are a number of methods that are employed to produce electrical power. In the U.S., three of the primarily methods for electric power generation are natural gas, coal, and nuclear power, for a total of 83.9% of the total electric power generated. There are also “green energies,” such as hydro, wind, biomass, solar, and geothermal, but currently they only make up 14.8% of the power production in the U.S.

As with any system design, there are pluses and minuses for all of the current forms of electric power generation. These differences range from operating costs, to reliability, to their environmental impact, among other differences. The following discussion will touch on some of the main characteristics of these electric power technologies.

One of the main considerations for any technology is its overall construction and operating costs, consider the following information.

TABLE 1
Typical capital and operating costs for
power plants. Note that these costs do not
include subsidies, incentives, or any
“social costs” (e.g., air or water emissions).

| | Capital Cost | Operating |
|---|---|---|
| Technology | ($/kW) | Cost ($/kWh) |
| Coal-fired combustion turbine | $500-$1,000 | $0.02-$0.04 |
| Natural gas combustion turbine | $400-$800 | $0.04-$0.10 |
| Coal gasification combined- | $1,000-$1,500 | $0.04-$0.08 |
| cycle (IGCC) | | |
| Natural gas combined-cycle | $600-$1,200 | $0.04-$0.10 |
| Wind turbine (includes | $1,200-$5,000 | Less than $0.01 |
| offshore wind) | | |
| Nuclear | $1,200-$5,000 | $0.02-$0.05 |
| Photovoltaic Solar | $4,500 and up | Less than $0.01 |
| Hydroelectric | $1,200-$5,000 | Less than $0.01 |

Some of the operating costs are quite low, such as photovoltaic (solar), wind turbine, and hydroelectric (e.g. less than $0.01/kWh), but their initial build costs are high (e.g. maximum initial capital estimates $5,000/kWh for wind turbines, $5,000/kWh for hydroelectric, and $4,500/kWh and up for solar). On the other hand, power generation systems that have a relatively low capital cost, such as natural gas (e.g. $800/kWh for natural gas turbine driven generator) can have higher operating costs (e.g. up to $0.10//kWh).

There are five main attributes for the new form of hydroelectric power presented herein, the submerged water column generator technology: 1—it can produce substantial levels of electrical power, potentially scalable into the hundreds of MW's per assembly; 2—it can be very low cost both in construction and its system operation; 3—it is a green form of electrical power with no output of CO₂ or other more hazardous pollutants; 4—it can supply large power outputs on demand; and 5—this is a novel form of untapped power generation that provides significant potential. As with any industry, the methods for electric power generation are numerous and like most electrical or mechanical systems (e.g. cars, planes, computers, tools, etc), there are pluses and minuses to each design. This new form of electrical power generation employs the freefall of water in submerged columns and this new design provides numerous advantages over all of the existing forms of electric power production and it has few negatives. Consider the following points.

There are manmade and natural examples that mimic the submerged water column generator technology, one of those manmade methods takes place when a building is being demolished. There is a great deal of Potential Energy (PE) that is stored in the structures of a tall building and when the building's lower support structures can be made to fail, with a relatively small amount of explosives or Activation Energy (AE), then a great deal of Kinetic Energy (KE) is released. As to natural examples, there is a great deal of PE in deep bodies of water, such as in deep lakes and oceans. There are times when that PE is turned into KE in ocean areas that experience major earthquakes. Consider the 2004 earthquake in the Indian Ocean near Indonesia. It is estimated that the ocean floor dropped 6.0′ in some areas and the amount of ocean floor displaced resulted in the freefall of 1,750 cubic miles of water and the final energy released was estimated to be 26 megatons of TNT. So, this is a natural example where large levels of PE, (deep water), can be turned into significant levels KE (freefalling water and resulting tidal waves) with some form of AE (ocean floor drop). The two previous examples are not useable forms of KE but there is a way to use the PE in deep bodies of water and turn that PE into KE, with a small amount of AE and that KE can then be tapped with hydroelectric systems and turned into useable electrical power.

Very high levels of electrical power can be obtained from the Potential Energy (PE), which is present in deep lakes and oceans. It is a simple matter of submerging a large diameter flow pipe in deep bodies of water, where the top mouth of the pipe would be tens of feet, to hundreds of feet below the surface. The pipe could be from 100 feet to several hundred feet long, but shorter length may also be possible. Some systems for power generation would be in the lower section of the Water Column, such as a turbine driven generator. And, at the base of that Water Column would be some form of water evacuation pump. So the question arises, how do you turn those extremely large amounts of PE that are present in deep bodies of water into substantial levels of useful KE? It may be a simple matter of employing AE, in the form of moving the lower volumes of water, in that Water Column, to the side or out of the way of the upper volumes of water that are present in that tall Water Column. It does not take much energy to pump the lower volumes of water to the side and this allows the upper volumes of water in the Water Column, to go into freefall. Note: once water freefall can be initiated, by pumping the water out of the base of the Water Column and/or by pumping water into the top of the Water Column; that freefalling water may be self-sustaining and further flow activation may not be required, or it may only require periodic flow activation, or a lower level of power input would be needed once the max flow is initiated. That freefalling water provides extremely high levels of KE (e.g. ½ m V²), because the water is relatively massive or dense and if the freefall heights are considerable the flow speeds will be high. As a comparison of the available power from a water turbine versus a wind turbine, consider the following power formula P=½ ␣␣HA V³. Assume all of the variables are the same (e.g. (eta)=efficiency_␣A=Area, V=Velocity) except the density (ro) of water versus the density of air, then the Power (P) generated from a water turbine versus an air driven turbine, at sea level, would be 784 times greater. So another way of looking at it, if a water turbine and a gas or air turbine had the exact same design, such as, eta=0.85, A=100 ft², V=25 ft/sec; then 784 wind turbines would be needed to produce the same power as one water turbine of the same size. So, the fast-flowing water can be tapped with turbine generators and other forms of water flow generators, to produce substantial levels of electrical power. The basic model would entail relatively deep bodies of water which provide large levels of PE and the majority of that PE can be converted into KE and then useable power, with what could be a relatively small amount of AE. In fact, from a number of preliminary calculations, the KE can easily produce hundreds of times more energy than the AE required to initiate the fluid flow. So as one example, an evacuation pump that requires 1 MW of power to operate, could potentially drive a submerged water column generator to produce 300 MW of power. However, those numbers could change drastically based on different system designs.

One of the advantages of the submerged water column generators is the fact that the electric power that they produce, should be one of the lowest cost methods for generating electric power; much like the power from hydroelectric dams and solar cell farms. The power costs for submerged water column generators should be less than $0.01/kWh, but this new form of power generation does not have the high capital costs, to construct and install the power generating hardware and support facilities, as with hydroelectric dams and solar farms. Another advantage is the fact that there is no CO₂ output nor other forms of airborne pollutants, as with coal and natural gas fired power plants. And, there is no nuclear waste to store or properly dispose of, plus, there is no risk of the release of hazardous radioactive waste, when a nuclear power plant is damaged by natural and/or manmade disaster, as with the reactors in Fukushima, Japan and Chernobyl, Russia. The only pollutant from a submerged water column generator would be a slight temperature drop from the energy being removed from the water flowing through the system. As one example of the preliminary designs for a submerged water column generator, supplied 105 MW of electrical power and the water temperature drop for that system may only be 1.9 degrees Fahrenheit. That temperature drop relates to only the water that passed through the system. Also, it would take 600 days of continuous operations, to deliver that same temperature drop, to one cubic mile of water (e.g. this assumes that no other heat transfer events are experienced in that cubic mile of water within 600 days, which is obviously not the case). So, the submerged water column generator is a very green electric energy production method. In fact, it is actually greener than some of the other “green” power generation systems because both solar furnaces and wind turbines kill birds in flight and the turbine blades in the tidal generators, can kill both small and large marine life. The submerged water column generator would have water filtration systems, at the Water Column entry point, thereby preventing the entry of small and large aquatic life forms (microscopic life forms such as plankton would still pass through the Water Column) plus this filtration system can be employed to prevent entry of manmade plastics and other manmade solid waste. This solid waste would be collected by the filtration system and then be cleared and collected so that it could be recycled and/or put in a landfill.

Another area where these submerged water column generators excel over existing green power systems is fact that this new power system can supply power on demand. So unlike power systems that cannot always supply power on demand, such as a solar cell farms at night; or windmills on a calm day; or only 14 hours of operation each day with a tidal power system; the submerged water column generators can deliver power, whenever that power is needed. So if the power grid needs 500 MWs of electric power immediately, then the activation of 2 to 3 water column generators could be started to meet that demand. Another advantage to a submerged water column generator is its rapid startup times. Existing hydroelectric systems take about 60 to 90 seconds to bring a generator from cold start-up to full load. Compare these startup times to the 24 hours, to several days, for many of the thermal power plants (e.g. coal, some natural gas, nuclear). Also, like hydroelectric dams, the submerged water column generators may have a very high power output efficiency, ranging from as much as 85% to 90%, depending on design decisions. While the next attribute is not related to generating power, it is another green aspect of the technology, and that is the possibility of adding some level of oxygen to the water that is flowing through each submerged water column generator. Currently there are die-off zones in the world's oceans because the oxygen levels have dropped too low in some regions, to the point that many aquatic life forms cannot survive. Some theories relate these die-offs to more ultraviolet rays making it through the atmosphere and thereby killing off notable levels of the world's plankton levels. So the water flowing through each water column generator would not only produce substantial levels of power but it could also oxygenate the water. To force pressurized air into the freefalling water columns, the needed power levels would be low, possibly less than 1% of the total power output of each water column generator. Therefore, each one of these generators could oxygenate a cubic mile of water every 600 days.

There are actually fewer limits on submerged water column generators than with hydroelectric dams and so the available power output can be much greater. For instance, a dam's height is limited because of the surrounding topography and the available size of the rivers supplying a particular hydroelectric dam, but the submerged water column generators can be set in very deep ocean waters. An interesting point is, the available power actually increase not linearly but instead by the height to the 3/2 power (e.g. h^{3/2}; where h is the height of the water from the surface of the body of water, to the exit point at the bottom of the Water Column). So, if you had a submerged water column generator with a 500′ exit point at the base of the Water Column, versus another design with a 1,000′ drop to the Water Column's exit point, then the power wouldn't just be 2 times greater because the height increased by 2 times but instead the power output would increase by 2.828 times (e.g. 1000^{3/2}/500^{3/2}=2.828 not 2.0). The absolute depth of the system below the water surface may also contribute to increased power output, due to increased inlet water pressure at the opening of the submerged water column generator. Another point for this new form of hydropower is the fact that the operation zones can be much deeper than other forms of hydropower, by doing this, not only can the power output be increased by depth to the 3/2 power (e.g. h^{3/2}) but the chances of water flow cavitation will be greatly reduced, if not eliminated completely. This reduced chance of cavitation means that tighter venturi sections can be used and this can increase the power output even further, by the square of the velocity.

For instance, consider one possible calculation. In one possible analysis, the power from a turbine P=½ (eta)(ro)A V³; and constant mass flow A₁ V₁=A₂ V₂; assume that A₂=⅓ A₁ therefore V₂=3V₁; so in a venturi, the area would drop by ⅓ but the velocity factor would increase by the power of 3 (e.g. 3³=27) so the power increases by V₂² or in this example 9 times. Note that P=½ (eta)(ro)A V³=C₁ A₂ V₂³=C₁ ⅓ A₁ (3V₁)³=C₁ ⅓ (27) A₁ (V₁)³=C₁ 9 A₁ (V₁)³. Of course, this assumes that there is no cavitation or extreme flow interruption to affect the power formula.

The submerged water column generator concept is unique, in that it may use existing oil drilling platforms or they may be included in the design and construction of future oil drilling platforms. They may also be deployed in floating platforms, such as ships or dedicated floating structures, which would only be used for electrical power generation. The advantage of using existing oil drilling platforms is the capital has already been invested into the construction of these structures. There are currently some 27,000 used oil drilling platforms in the Gulf of Mexico; these platforms are in various states of repair. There are undoubtedly similar numbers of oil drilling platforms in other coastal waters. By using existing oil drilling platforms, a great deal of capital costs would be eliminated, so unlike many power production systems that require an expensive dam for hydroelectric, or large power facilities for coal, nuclear and some natural gas; a submerged water column generator would be more analogues to producing individual wind turbines and/or tidal hydro turbines. But again, a submerged water column generator may produce 100's of MWs of electricity instead of the 1 MW to 2 MW, from a windmill or tidal generator.

Another physical behavior that needs to be addressed will either be the tapping or mitigation of vortices or whirlpools that can potentially form due to the large volumes of water that freefall through a submerged water column generator. Vortex formation is driven by several factors such as the rotation of the earth or the Coriolis Effect, which is the driver for the circular motion of whirlpools, hurricanes and ocean currents. The Coriolis Effect causes counterclockwise rotation of weather patterns in the northern hemisphere and clockwise rotation in the southern hemisphere. The other drivers for whirlpool formation are the horizontal flow speeds and the depth at which the flow is initiated. So, the control of those 3 parameters will drive the potential for whirlpool formation, the Coriolis Effect has its greatest effect at the poles and decreases to zero at the equator. Also, if the drop speed of the water is more rapid then it has a greater influence on vortex formation. Lastly, the fluid entry points that are shallow have a greater chance of developing whirlpools because the horizontal flowing speeds toward the pipe are greater and so those high speed horizontal velocity vectors, are more influenced by the Coriolis Effect. So, if there is a high water speed downward and the entry port is near the surface and the submerged water column generator is located further north or south, then there is a greater chance of whirlpool or vortex formation. There are small examples of this when a person drains a bathtub, normally vortexes will form once the water level is relatively shallow, such as a few inches deep, but there are also more dramatic examples of major water whirlpool formation. For instance, in 1980 Lake Peigneur in Louisiana was actually drained because of an oil well that was being drilled in a 10.0′ deep lake. The bore shaft actually hit a salt mine and the lake water was able to flow into the 14.0″ diameter oil pipe and into the salt mine. The lake drained for 2 days and actually had reverse flow from the ocean. The whirlpool that developed was over 100.0′ in diameter and it actually brought in 11 barges during its draining.

Vortex formation may not be a problem with the deeper depths where submerged water column generators normally operate but the flow speed will be substantial, so there may be a need to have some form of vortex mitigation. There are a number of design types that can address this potential problem, such as active flow systems near the mouth of the Water Columns that could re-vector the flow direction, also some designs may be mounted at different depths above the submerged water column generator.

As a non-limiting example, the preferred embodiment of the submerged water column generator concept may include a column that is substantially vertical, with an inlet for the fluid. The fluid may flow into the column when it is opened, and once the support fluid is pumped out of the base of the column and/or when fluid is pumped into the top of the column and/or when fluid flow input or expulsion is delivered at various points on the fluid column. This fluid movement may be accomplished by at least one pump. Once the flow is initiated large masses of fluids will then be freed and they will flow downwards with gravity towards a power generation system, such as a fluid turbine. The falling water may activate the fluid turbine to create energy.

### BRIEF DESCRIPTION OF THE DRAWINGS

The basic components shown and numbered in each sketch from FIG. 1 to FIG. 19 show the basic design concept of generating electric power from the freefall of water in submerged water columns. Note, some of the same numbered components are displayed in more than one sketch.

FIG. 1 is a sketch of a building undergoing demolition and there are actually some similarities between this process and a submerged water column generators stem. There is a great deal of Potential Energy in the building's structure and that potential energy is being converted to Kinetic Energy by failing the lower support structures with a small amount of Activation Energy (relatively small amounts of explosives versus the Kinetic Energy of the freefalling structures).

FIG. 2 is a side panoramic view of an oil platform that has 2 possible designs of the submerged water column generator assemblies mounted on that platform at different depths. The generator assembly and/or assemblies could be mounted on retired or operational oil drilling platforms and/or possibly ship platforms (not shown).

FIG. 3 shows a close up isometric view of one embodiment of the submerged water column generator assembly that would employ hydro turbine generators and possibly hydro turbines for the evacuation pumps with the important components labeled.

FIG. 4 shows a more close-up isometric view of one embodiment of the hydro turbine assembly and the lower evacuation pump assembly that is inside the lower collection chamber.

FIG. 5 shows an isometric view of a sketch using some level of surfacing of the hydro turbine assembly to better convey the layout of some potential designs.

FIG. 6 shows the basic layout of a submerged water column generator system where the overall generator assembly would be mounted or set at a deep depth to provide high PE which would then be converted to KE by using a relatively low level of AE. FIG. 6 gives an idea of the overall flow behavior in the system, where an attempt would be made to keep the intake flow speeds of the water low, by having filtration system with very large areas. The flow speeds in the Water Column would be kept high by having large drop heights of the water column and venturi sections in the power production zones and lastly, the AE would be low because the fluid flow parameters would have essentially no pressure or height differential, so it is a simple matter of pumping the water to side, at the same depth but out of the way of the water in the upper sections of the flow tube.

FIG. 6A shows an isometric surface sketch of one embodiment of a tidal turbine design that has the generator assembly mounted in the outer circumference of the turbine generator assembly. The turbine blades are also mounted on the outer circumference, instead of the generator being mounted on a central axis.

FIG. 7 shows an isometric view of a submerged water column generator assembly that is mounted in the throat of a venturi section. The actual power will increase by the square of the velocity in the throat of the venturi but this is only if cavitation can be controlled in the re-expanding downstream venturi section.

FIG. 8 shows a close up isometric view of a venturi section where the turbine blade assembly and the generator are downsized to fit into the smaller cross-sectional area. The evacuation pumps could have a range of designs.

FIG. 9 shows an isometric of a partial surface version of one possible hydro turbine assembly mounted in a venturi section to better convey the layout of this potential design.

FIG. 10 shows a side view of an actual experiment where the water flow through the venturi actually cavitates. Cavitation can be controlled by the amount of venturi flow area restriction. While the velocity and the available power output increases with a restriction in the flow area, so do the chances of cavitation. But cavitation can be reduced and/or eliminated by locating the venturi sections at lower depths and therefore higher static pressures.

FIG. 11 shows an isometric of a potential designs for a submerged water column generator that would employ a Magnetohydrodynamic (MHD) Generator Assembly and a Magnetohydrodynamic (MHD) Propulsion Assembly. There would be no moving parts and so there would be no need for dynamic seals. Such a system could be advantageous at lower depths.

FIG. 12 shows a close up isometric view of the Magnetohydrodynamic (MHD) Generator Assembly and a Magnetohydrodynamic (MHD) Propulsion Assembly. It should be noted that the generators will produce DC current, so there will need to be inverters to deliver AC current to shore.

FIG. 13 shows a close up isometric of the top section of one embodiment of a submerged water column generator assembly with a compressed air system dispersing the air/oxygen into the falling water column. This process is not for generating electricity but for supplying oxygen to the volumes of water that would be circulated through submerged water column generator systems.

FIG. 14 is a side view of an oil well platform where an embodiment of submerged water column generator would employ a driveshaft. This driveshaft connects the turbine blade assembly to the topside mounted generator. The advantage of this design would be the prevention of exposing the generator to water, due to seal failure, because the generator is not submerged but instead would be installed in the upper oil well platform. There would also be some energy losses due to the skin friction drag losses of the spinning driveshaft but these losses should be nominal.

FIG. 15 is an isometric view of a turbine blade assembly that would be attached to a driveshaft and that driveshaft would be attached to a topside mounted generator. Much of the hardware is the same as earlier versions of the submerged water column generator, except for the driveshaft which attaches the turbine blade assembly to the topside mounted generator. Also in this design the lower evacuation pump system would need a small amount of electrical power to initiate the freefall flow.

FIG. 16 is an isometric view of a turbine blade assembly exactly the same to configuration shown in FIG. 15 except some of the system hardware being shown with surface modeling those being the driveshaft, the turbine assembly and the lower evacuation pump system.

FIG. 17 is an isometric view of the upper platform with its lower foundation structures. The electric generator would be installed in the upper platform and a driveshaft would extend from the electric generator down to the turbine blade assembly and this would provide the electric power.

FIG. 18 shows an isometric view of a Magnetohydrodynamic (MHD) generator assembly but the Magnetohydrodynamic (MHD) propulsion assembly design is not being shown because the both Magnetohydrodynamic (MHD) systems have similar construction and operation. The purpose of this FIG. 18 is to provide a model to show the section cuts, those being, Section 19 A and Section 10 B to give a better view of the of a basic inflatable water bladder design.

Section 19 A and Section 19 B shows the potential layout of inflatable water bladders which would be attached to magnet inner surfaces, of generator assembly as shown in Section 19 A and another set of inflatable water bladders would be used on the anode and the cathode surfaces, as shown in Section 19 B. By inflating these bladders periodically the calcified mineral layers would be removed.

FIG. 20 shows an isometric view of one embodiment of the submerged water column generator assembly that would employ hydro turbine generators and possibly hydro turbines for the evacuation pumps with the important components labeled. In addition, this design will reduce the chances of the formation of vortices or whirlpools because of the multiple entry ports on the upper Water Column. These flow ports will reduce the entry speeds and disperse the water's entry points over a larger area, by doing this, the chances of whirlpool formation will be greatly reduced. This particular design also shows a potential vacuum ring around the flow tube to clear the screens around the flow ports of debris.

FIG. 21 shows a perforated flow vectoring wall with an “X” cross section. Also, the walls would have flow porting in the walls to disrupt any potential vortex or whirlpool formation.

### FEATURES

10—Is the Large Amount of Stored Potential Energy (PE) in the Building's Structure
20—Is the Large Amount of Kinetic Energy (KE) that is being Released
30—A Small Amount of Activation Energy (AE) or Explosives which Fail the Lower Support Structures
40—Building before Demolition
50—Building during Demolition
100—Upper Platform
110—Foundation Structure for the Oil Platform
120—Moderate Depth Submerged Water Column Generator Assembly
130—Deep Depth Submerged Water Column Generator Assembly
140—Moderate Depth Power Cable from Generator to Platform
150—Deep Depth Power Cable from Generator to Platform
160—Power Cable from Platform to Land Power Grid
170—Ocean or Lake Surface
180—Ocean or Lake Floor
200—Upper Flow Filer Structure
210—Circumferential Flow Filer Structure
220—Water Column
230—Upper Attach/Mounting Structure
240—Lower Attach/Mounting Structure
250—Hydro Turbine Power Assembly
260—Lower Evacuation Pump Assembly
300—Turbine Blade Assembly
310—Electric Generator
320—Perforated Dispersion Plate to Disperse Flow
330—Lower Collection Chamber to Control Water Evacuation
340—Turbo Pumps or Alternate Pump Design/s to Provide Water Evacuation
500—Intake Water being Filtered
510—Large Volumes of Freefalling Water
520—Lower Volumes of Support Water Being Pumped to the Side
530—Turbine Generator Assembly with Generator in Exterior Circumference
540—Turbine Blades Mounted to Outer Circumference
550—Generator Mounted to Outer Circumference
600—Venturi Flow Tube
610—Reduced Sized Venturi Deep Depth Submerged Water Column Generator Assembly
700—Reduced Sized Turbine Blade Assembly
710—Compact Electric Generator
800—Venturi Tube in Water Flow Experiment
810—Cavitation of Water Flow
820—Throat of the Venturi
830—Mouth of Venturi
840—Water Flow Direction
850—Convergent Section
860—Divergent Section
900—Upper Flow Transition Pipe from Round to Rectangular
910—Lower Flow Transition Pipe from Rectangular to Round
920—Magnetohydrodynamic (MHD) Generator Assembly
930—Magnetohydrodynamic (MHD) Propulsion Assembly
1000—Magnet Part of Generator Assembly with North Pole Facing Outward
1010—Magnet Part of Generator Assembly with South Pole Facing Outward
1020—Anode (+) Connected to Positive Power Source (Generates DC Current)
1030—Cathode (−) Connected to Negative Power Source (Generates DC Current)
1040—Magnet Part of Propulsion Assembly with North Pole Facing Outward
1050—Magnet Part of Propulsion Assembly with South Pole Facing Outward
1060—Anode (+) Connected to Positive Power Source (Powered by DC Current)
1070—Diode (−) Connected to Negative Power Source (Powered by DC Current)
1100—Compressed Air Pipe from Surface Air Compressor
1110—Perforated Pipe Section in Water Column
1120—Compressed Air Being Released In Water Column
1200—Submerged Water Column Generator with Driveshaft
1210—Evacuation Pumps Power Cable
1220—Support Bearing Mounts
1230—Driveshaft
1240—Topside Mounted Generator
1300—Turbine Blade Assembly Attached to Driveshaft
1400—Inflatable Water Bladder for Magnet Surfaces
1410—Inflatable Water Bladder for Anode and Cathode Surfaces
1500—Upper Water Column with Entry Ports and Filtration Screening
1510—Vacuum Flow Pump Cleaner to Force Water and Debris to Surface for Sorting
1520—Flexible Water Column to Connect Vacuum Cleaner to Surface Sorter.

### DETAILED DESCRIPTION

While the exemplary embodiments illustrated herein may show various features, it will be understood that the different features disclosed herein can be combined variously to achieve the objectives of the present invention.

At the outset, the present invention relates to hydroelectric power generation systems. The present invention starts with a hollow fluid flow column, which can have a wide variety of different design implementations, including tubes, pipes, channels, or ducts, among other designs. As noted in the equations below, the system would work most effectively with the column parallel to the vector of the acceleration due to gravity, which in most cases, would be roughly perpendicular to the ground or the surface of a body of water. However, it could still function being substantially parallel to gravity, which could be at some angle of orientation relative to gravity. At one end of the fluid flow column there may be an inlet where fluid (such as water) may enter the column and begin to accelerate and fall down the column due to gravity. This inlet may be continuously open or have a cover which can be opened or closed depending on usage. The inlet could also be automatically actuated with a control system, based on usage requirements, load schedules, or other system parameters.

At some distance from the inlet distally down the column, a fluid flow activator system or fluid flow pump may be positioned within or outside of the column, such as the accelerating and falling fluid flows past the fluid flow activator system which imparts its energy to the supporting water column thereby removing the support and allowing the vast amounts of Potential Energy (PE) in the upper water volumes to go into freefall and deliver their energies to the power generation system. If fluid is pumped into the inlet, or falls by gravity through the inlet, the fluid flows past a fluid power generation system. One example of a power generation system may be a fluid turbine (or multiple fluid turbines), or a magnetohydrodynamic power generation system, or any other fluid power generation system known in the art. The fluid turbine could have an attached electric power generation system, have one attached on a driveshaft, geared to the turbine, or in mechanical communication in any way known in the art for hydroelectric power generation. After energy is imparted from the fluid to the power generation system, at the distal end of the column, then one or more pumps move the fluid on out of the column, to the surrounding area, which may be submerged under water. As an alternative, the pump could be connected to the shaft of the fluid turbine, could be a piston pump, centrifugal pump, magnetohydrodynamic (MHD) propulsion system, or any other method of removing water to a different space outside of the fluid column known in the art may be used.

In one embodiment of the system, water may enter the inlet, flow past a fluid turbine, then be pumped out of the opposite end of the column by pumps, either in the distal end of the column or outside of the column, pumping the water out of the column after it was flowed past the fluid turbine. However, in another embodiment of the system, pumps may flow water into the column near the inlet, where the water flows downwards past the fluid turbine. In yet another embodiment, one pump system could be used to accomplish both functions in the same system.

For the purposes of this disclosure, a fluid power generation system may include both the fluid power system, such as a fluid turbine, but also an electrical generator in communication with the fluid turbine, such as an electrical generator. Therefore, the fluid power generation system may extract power from the falling water, generate electricity from it, then send that electricity through a power distribution circuit or controller, which may send the power to the network where it is needed, or store the power for later usage. These functions may all be programmed into the controller operable to manage the overall system function.

In another possible embodiment, the system may be integrated with a separate power generation system. For example, the fluid power generation system may be in communication with a separate solar power panel and a battery. In this embodiment, power generated by the fluid power generation system may be stored in the battery system for later use. Or, power from the separate power generation system may be sent to the pump system to power it externally. In this way, the fluid power generation system may be integrated with the pump system, a separate power generator, a power storage system, or any combinations of this system, which are controlled by a control system to optimally power and operate the system based on power requirement, load scheduling, or other system requirements.

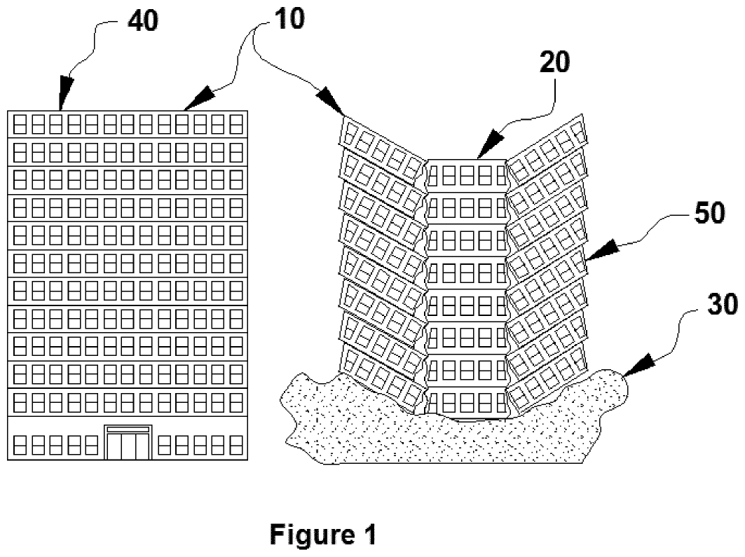

The pumping system may be powered in a number of different ways. The pumps may be powered by energy generated in the fluid power generation system, or by an external source, by power stored in batteries, or any combination of these sources. Any external source could potentially be used to power the pumps, including renewable energy sources such as a solar panel, or any other power system known in the art. And, power generated in the system may be stored in batteries for the ability to activate the pump system at any time. For example, one embodiment may operate the pumps in real time to evacuate the water immediately thereby initiate the flow past the fluid power system. However, another possible embodiment would collect the post-turbine water at the bottom of the fluid column and pump it out slowly over time. In such an embodiment, the inlet may be closed during the pumping period to prevent new fluid from entering. A comprehensive control system may be integrated with the system to control the inlet of water, power taken from the fluid turbine, power storage, and the pumping cycle to optimize power generation. Obviously, there are a number of different configurations and embodiments, that can all be arrange variously, and fall within the spirit of this invention. As a further overview of the overall system operation, FIG. 1 gives an existing example of converting large levels of Potential Energy (PE) 10 into Kinetic Energy (KE) 20 by investing a relatively small amount of Activation Energy (AE) 30. FIG. 1 shows the demolition of a large building before demolition 40 and once demolition has been initiated AE 30 and the building starts to collapse 50 and releases the KE 20. A relatively small amount of explosives AE 30 is used to fail the lower support columns thereby initiating the collapse of the building 50. So, for a small amount of AE 30, all of the PE 10 in the weight of the concrete, steel and other materials is turned into high levels of KE 20 by causing that building mass to go into freefall 50. The KE 20 is so extreme that it pulverizes the concrete and bends the heavy gauge I-beams.

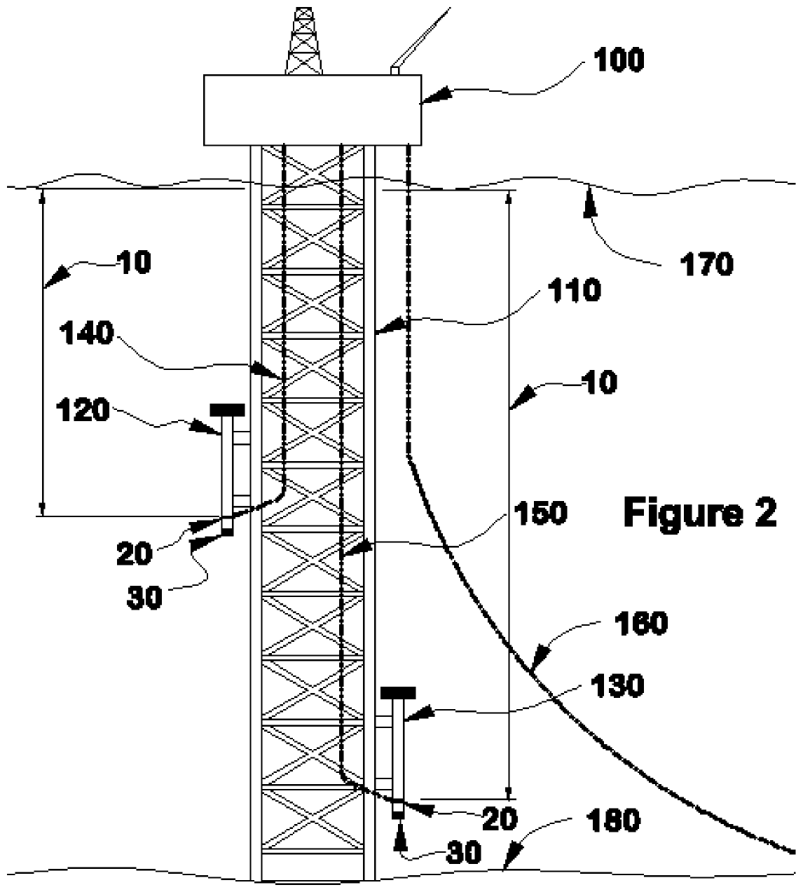

FIG. 2 shows a practical example of taking PE 10 and turning it into KE 20 by investing a small amount of AE 30 but in this design, the KE 20 is converted into usable electrical power. FIG. 2 gives a more complete view of possible mounting locations for submerged water column generators 120 and 130. Of course, these new generators would be submerged to the lowest depths possible, from the surface 170, with the only limits being the system hardware 120 and 130 performance, depth limits on the support structure 110 and environmental impact at different depths. In this example, an active or retired oil well platform 100 would have one or more water column generator assemblies 120 and 130 mounted to the lower support structure 110 of the oil well platform 100. The generator assemblies 120 and 130 would be set at predetermined depths to obtain the optimum power generation, for a particular location of an oil well platform 100 and the available ocean or reservoir depths. The power generating output will increase with depth but there are other factors that drive the depth location of the column generator assemblies 120 and 130. There may be operation limits to the hardware of the column generator assemblies 120 and 130, such as possible seal failure, for some designs and/or there may be environmental concerns for increased water flow at lower depths, such as erosion of sediment on the ocean floor 180. The power generated from the column generator assemblies 120 and 130 could be transmitted to the surface by power cables 140 and 150 and the upper power controls would deliver that power to shore through a submerged power cable 160 which would be set on the ocean floor 180.

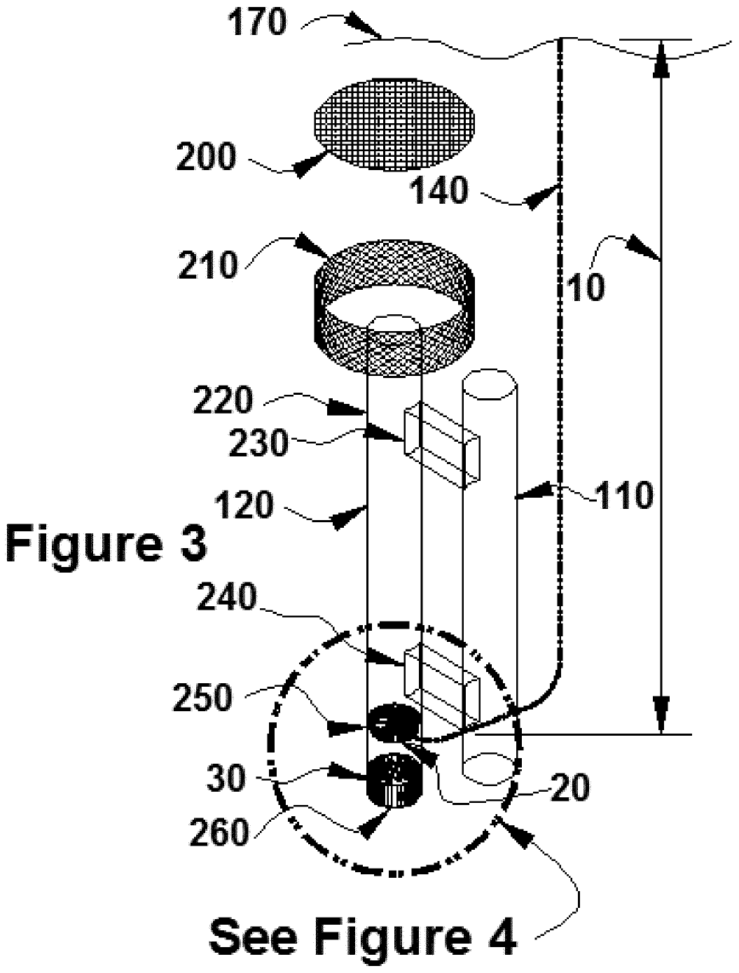

Turning to FIG. 3, this figure shows a more detailed view of a one embodiment of a submerged water column generator design 120. In this design the KE 20 would be turned into electrical power with a turbine generator 250. Again, the available KE 20 would be determined by the placement depth and the resulting PE 10. This design also shows a potential embodiment with a filtration system 200 and 210 to prevent the generator assembly 120 from drawing in sea life or manmade and natural debris. The Water Column 220 could be designed to an optimal wall thickness and length after computer modeling. There may also be mounting structures 230 and 240 so that the submerged water column generators 120 could be attached to the oil well platform structure 110. At the base of the Water Column 220 is the evacuation assembly 260 which act as the AE 30 to remove the water layer from the lower section of the Water Column 220 so that the water in the Water Column 220 can go into freefall. The PE 10 is the distance between the water surface 170 and the generator assembly 250 and that PE 10 can be converted into KE 20 and then electrical energy with the generator assembly 250. The water flow can be initiated by pumping the lower water volumes 260 out of the lower section of the Water Column 220; this is a form of AE 30. The power generated by the generator assembly 250 would be transferred to the upper platform 100 by the moderate depth power cable 140.

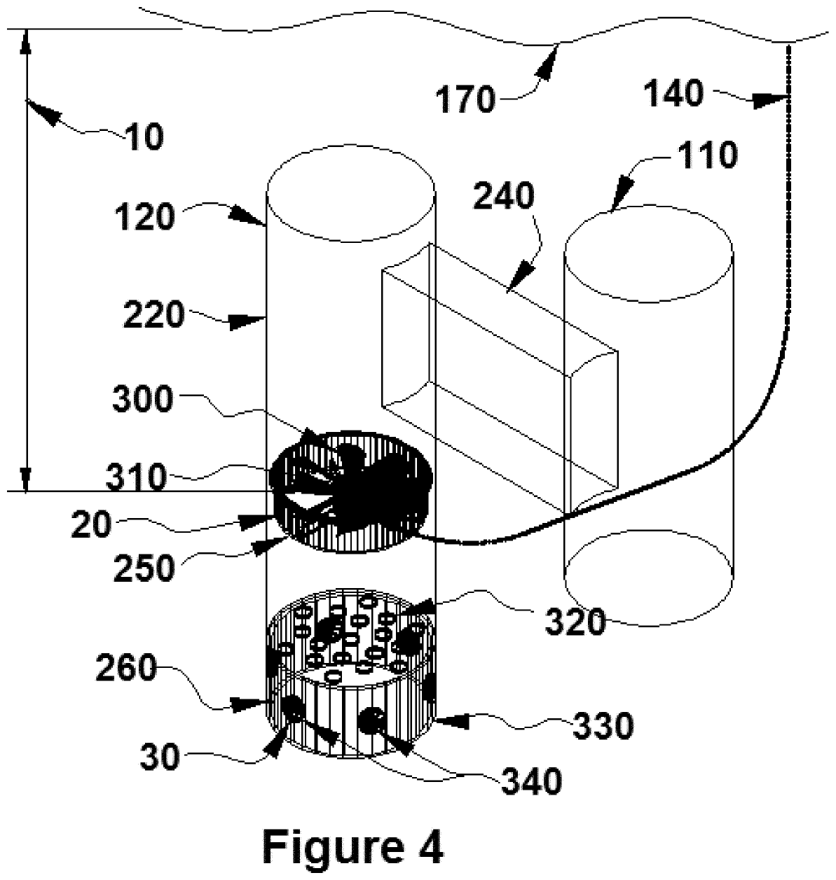

FIG. 4 is an even closer view of one embodiment of a submerged water column generator 120 design. The lower section of the Water Column 220 is shown, the lower support structure 240 is shown attached to the oil well platform structure 110. The turbine generator assembly 250 is shown in more detail with the flow turbine blade assembly 300 and the electric generator 310. In this embodiment, a lower flow dispersion plate 320 is shown, the purpose of the plate may be to make the flow evacuation of the lower chamber 330 to be more uniform. As described above, some type of flow pump system would be needed to evacuate the lower chamber 330 and a series of turbine pumps 340 are shown, although any other fluid evacuation system known in the art may be used. This evacuation assembly 260 again acts as the flow imitator and therefore the AE 30. By evacuating the lower chamber 330 the water in the upper section of the Water Column 220 goes into freefall and thus converts the PE 10 into KE 20 which is tapped by the generator assembly 250. And the available PE 10 is related to the depth of the submerged water column generator's 120 turbine generator assembly 250, which is calculated by the distance from the ocean or lake surface 170 down to the turbine generator assembly 250, plus the area of the turbine generator assembly. The power that is generated by the turbine generator assembly 250 may be transmitted to the upper platform 100 by moderate depth power cable 140, although other power transmission methods may be used.

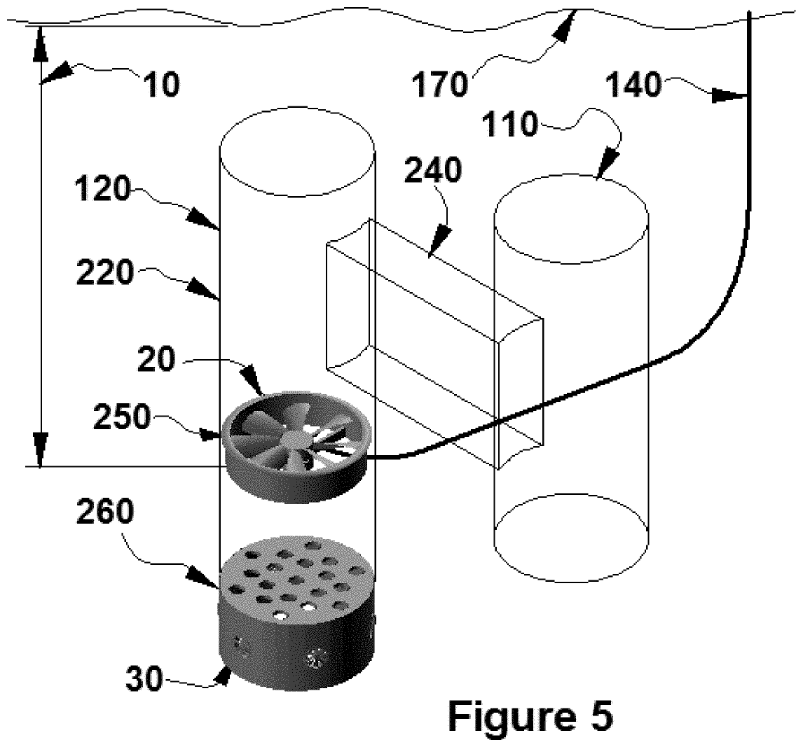

Turning to FIG. 5, this figure shows the lower section of an embodiment of a submerged water column generator 120 but FIG. 5 has also been surfaced, to give a clearer view of the structures and provide a better understanding of the general structures and their layout. The Water Column 220 and the lower mounting structure 240 are both shown, along with a section of the foundation structure for the oil platform 110 and the moderate depth power cable from the generator assembly 250 to the upper platform 110, which may be above the water surface 170. A surface view of the turbine generator 250 is shown which gives more detail, plus the lower evacuation assembly 260 is also surfaced to give a better understanding of the potential structural design. The basic physics of the submerged water column generator 120 is shown, where the PE 10 depth is the distance from the water surface 170 to the turbine generator assembly 250. Of course, the Potential Energy PE 10 converts equally, with no presumed losses, directly to the Kinetic Energy KE 20 minus the Activation Energy AE 30 which is the water being pumped out of the lower evacuation assembly 260. Obviously, the removal of the lower water volume may be needed to allow the upper water volumes in the Water Column 220 to go into freefall and the energy from that fast flowing water, can now be taped with the turbine generator assembly 250. In different embodiments, this may be done immediately, in real time, or may be accomplished over some period of time.

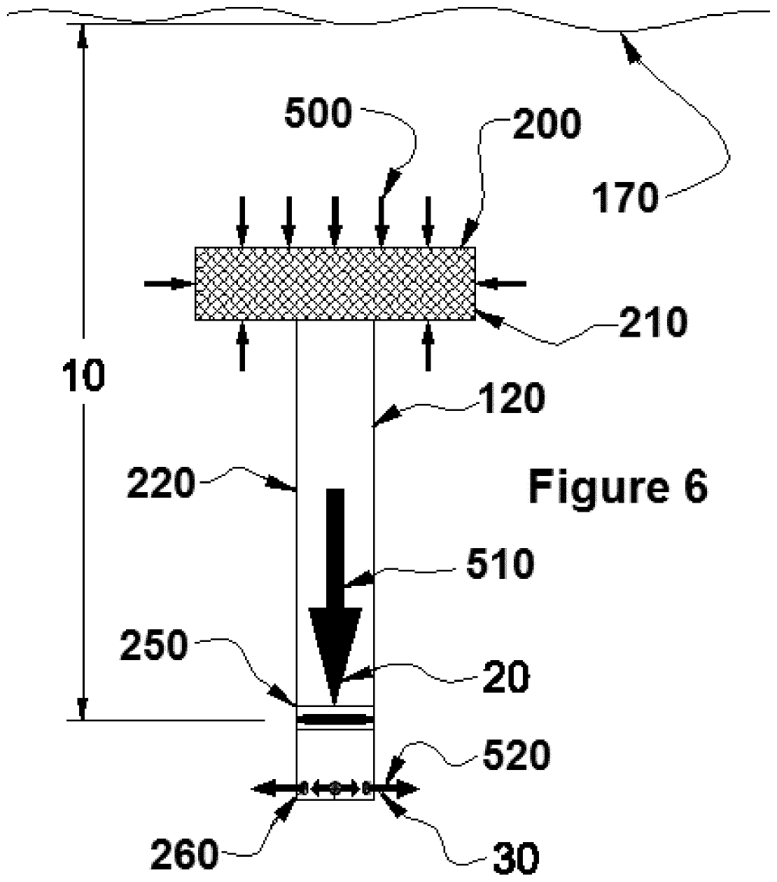

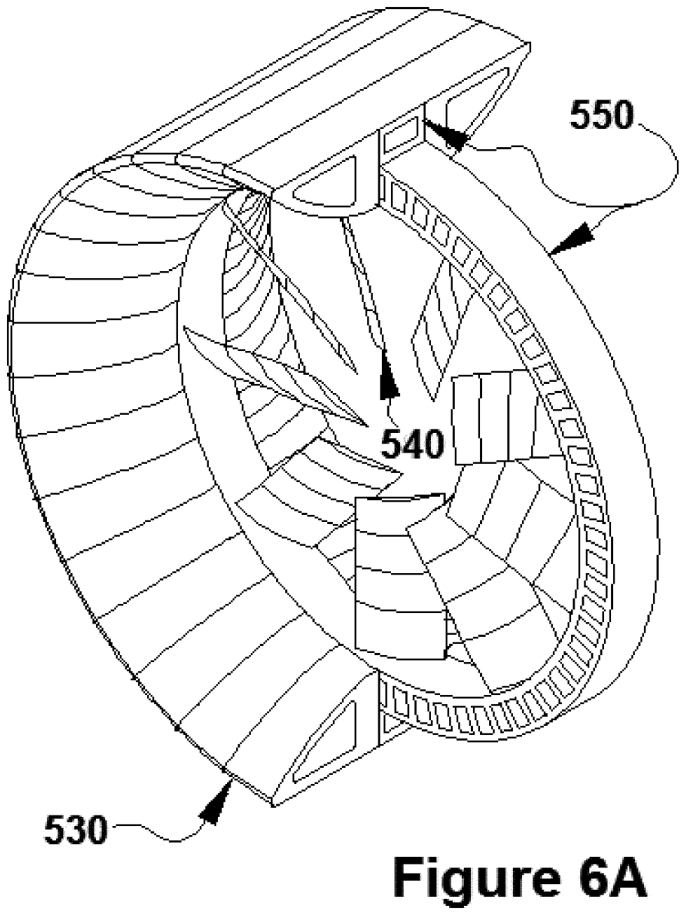

FIG. 6 shows a water column generator assembly 120 where the PE 10 is turned into larger volumes of freefalling water 510 and therefore into useable KE 20, by running a lower evacuation pump assembly 260 which act as AE 30 by pumping water to the side 520. And, since this water being discharged at the base 520 of the water column generator assembly 120, may be at the same pressures in some cases, both inside and out of the water column generator assembly 120 and the water pump height is essentially zero; there may be very little energy required to discharge that water 520 and 30 in some implementations, but not others. So again, the needed power to move that lower volume out of water, out of the way 520 of the upper column of water 510, so that that column of water can go into freefall 510, may be relatively low. As it turns out, the KE 20 in the freefalling water 510 in some designs and implementations, may be hundreds of times greater that the AE 30 needed to make the water, at the base, flow out of the way 520. The general water column generator assembly 120 may consist of a water filtration system 200 & 210 and this would allow water to flow and be filtered 500 into the Water Column 220 and that freefalling water 510 would drive the turbine generator 250 and produce electrical power.

FIG. 6A is a drawing of an existing tidal power generator 530. In this design the outer generator assembly 550 is not in the center of the generator assembly 530 but instead it is in the out circumference of the generator assembly 530. The design of this turbine blade assembly 540 may be similar to other turbine generator assemblies, where the generator assemblies are mounted at the center of the turbine blade assembly 540. The advantage of this design will be to increase the available generator performance, without affecting the flow behavior in the Water Column 220. The current tidal power generator 530 has about a 30.0′ diameter but it only produces 1.5 MW of electric power, whereas a submerged water column generator 120 has the potential of generating power levels of 100 MW and even greater levels because the flow speeds are so much higher. This available power may require an increase in the size of the generator structures 550. Of course, if the generator structures where mounted in the center of the turbine assembly 540 then the increased generator size could adversely affect the fluid flow but if the outer generator assembly 550 needs additional structure to provide increased power level performance, such power performance increases may not affect the fluid flow.

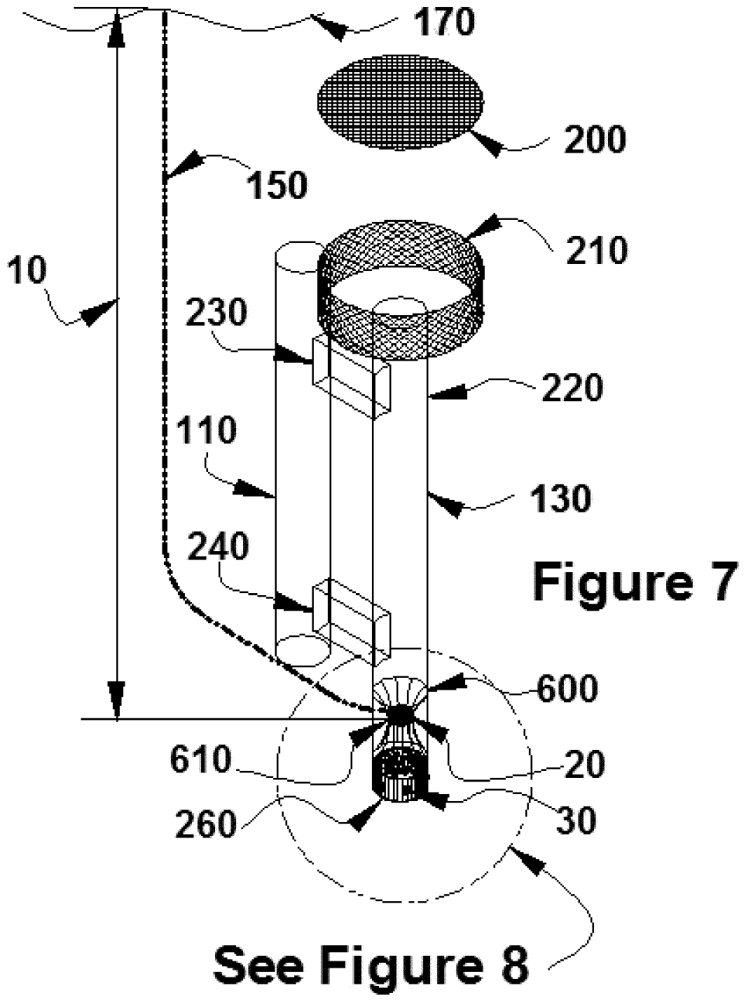

Turning to FIG. 7, this figure gives a detailed view of another design variance, for a submerged water column generator 130. There are two major design variances for this design, for instance the mounting depth, below the water surface 170 would be greater, and therefore the PE 10 would also be greater. The other variance would be the addition of a venturi flow tube 600 and the reduced sized electric power generator 610 would be mounted in that venturi flow tube 600. In this particular embodiment, all of the other previously mentioned structures and systems may be the same. So, this design would also have a filtration system 200 and 210, a Water Column 220, mounting structures 230 and 240 which would be attached to the oil well platform structure 110. Also, some form of evacuation assembly 260 may be required to provide the needed AE 30 to initiate the water freefall. One of the advantages of this design would be the possibility of increasing the KE 20 due to the increase flow speeds in the throat of the venturi tube 600 and with these increased flow speeds, the reduced sized electric power generator 610, would still produce more electrical power. The submerged water column generator 130 may have a deep depth power cable 150 attached to the electric power generator 610 and then to the surface of the upper platform 100.

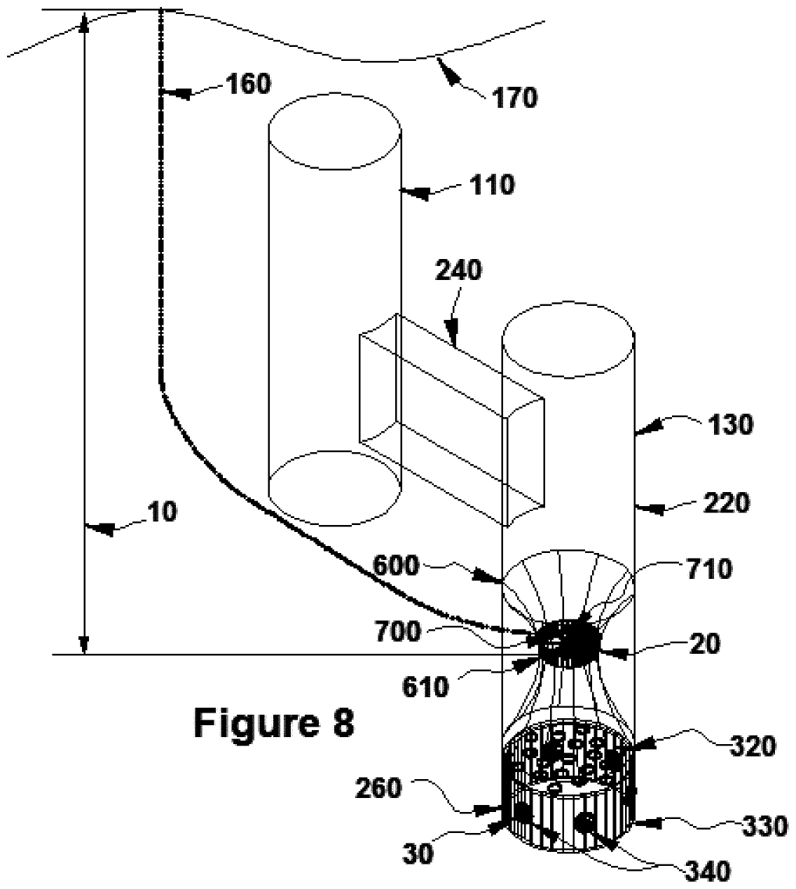

FIG. 8 is a close up view of FIG. 7 where the venturi assembly 600 is shown in more detail. Again, the submerged water column generator 130 is shown with its Water Column 220 and one of the mounting structures 240 which is attached to the platform structure 110. The venturi assembly 600 contains the electric power generator assembly 610 which contains the reduced sized turbine blades 700 and the compact electric generator 710. The location of the power generator assembly 610 may need to be set at deeper depths below the surface 170, to help prevent cavitation, therefore the PE 10 will also be greater and since the PE 10 has been increased, the KE 20 can also be increased. In this embodiment, the lower evacuation assembly 260 may consist of a lower collection chamber 330, along with a perforated dispersion plate 320, to assure that the water flow is consistent over all of the Water Column 220 area. Again, there can be a number of designs for the ejection pump system to expel water out of the base of the submerged water column generator 130 but the lower collection chamber 330 in this design has a series of turbo pumps 340 around the circumference of the lower collection chamber 330. These lower turbo pumps 340 will provide the AE 30 to start the freefall of the water in the Water Column 220.

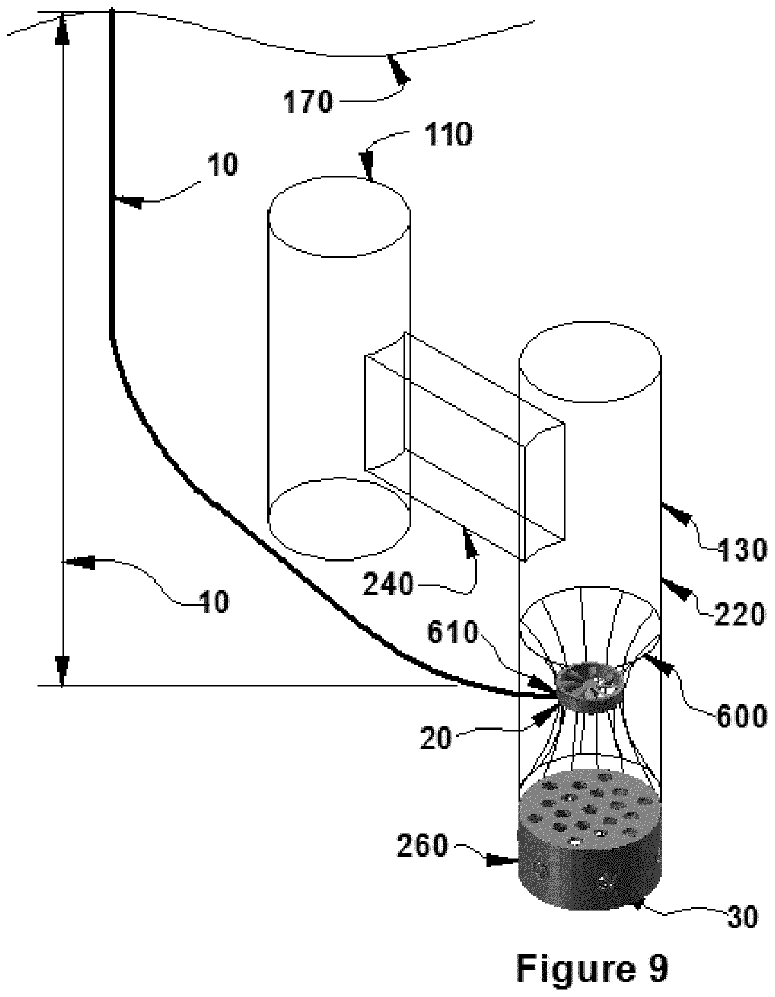

FIG. 9 shows the lower section of the submerged water column generator 130 with some surfaces shown on some of the assemblies, those being the power generator assembly 610 and the lower evacuation assembly 260. This design has a venturi assembly 600 to speed up the flow but by doing this there may be a chance of flow cavitation and to prevent this, the submerged water column generator 130 can be set at a deeper depth. The mounting structure 240 is attached to the foundation structure 110 and the Water Column 220. The deep depth power cable 150 is attached to the power generator assembly 610 and goes to the ocean surface 170 and is attached to the upper platform 100. Again, the PE 10 is converted to KE 20 by pumping out the lower support water with the evacuation assembly 260 which is acting as the AE 30 and the KE 20 is converted to electrical energy with the power generator assembly 610.

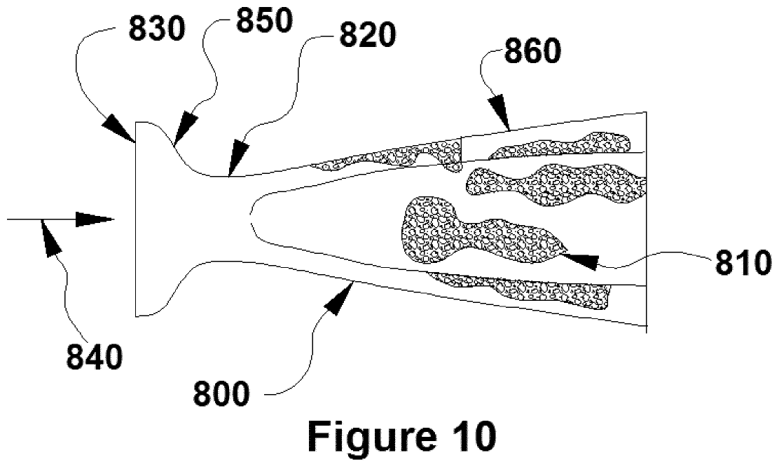

FIG. 10 shows water flowing 840 through a clear venturi tube 800. When water flows 840 through a venturi tube 800 the flow speeds will increase at the throat of the venturi 820 because the flow area at the throat of the venturi 820 is smaller than the area at the mouth of the venturi 830. So, the water flows 840 through the mouth of the venturi 830 and the water speed increases as it goes through the convergent section 850 through the throat of the venturi 820 and then ideally the flow will decelerate in the divergent section 860 without cavitation of the water flow 810. If there is flow cavitation 810, the water flow 840 would be disrupted in the venturi tube 800 and the flow behavior would not act like an ideal venturi and the following flow formulas would not be correct. This is an example of conservation of mass flow where A₁ V₁=A₂ V₂ or for this example, Aₘₒᵤₜₕ Vₘₒᵤₜₕ=A_{Throat} V_{Throat}. So, when the water flows 840 from the area of the mouth of the venture 830 to a smaller throat area of the venture 820 (e.g. Aₘₒᵤₜₕ>A_{Throat}); then the flow speed at the mouth of the venturi 830 must increase, when it reaches the smaller throat area of the venturi 820 (e.g. Vₘₒᵤₜₕ<V_{Throat}). This provides the potential of tapping more energy from these higher flow speeds but there are potential problems that need to be considered and that is, the cavitation of the water flow 810. Cavitation occurs in fluid flow systems when the local static pressure is below the vapor pressure. The 2 main variables that cause cavitation in the water flow 810 are the flow speed and the static pressure. Therefore, if you can obtain higher flow speeds, as with the freefall speeds in a submerged water column generator 120, and in addition to that, you increase the flow velocities by running the freefalling water through a venture tube 600 & 800 and lastly, there are high rotation speeds of turbine blades 700; then you have the chance of cavitation 810. To reduce the chances of experiencing damaging cavitation all that is needed is an increase in the operation depth; this will increase the surrounding static pressure and therefore prevent cavitation. The cavitation formula is K=2 (Ps−Pv)/((ro)V²) where K gives a value where cavitation may occur; at the depth where the electric power generator assembly 610 is located, is where the static pressure Ps would be measured; Pv is the water vapor pressure at a particular temperature; □ is the water density; and V is the velocity of the water flow. As an example of operating depths where cavitation may occur, one scientific study ran a series of flow tests on a venturi and their test model showed signs of cavitation inception when K=0.84 to 0.93, whereas severe pressure pulsations and fully developed cavitation was observed when cavitation numbers reached K=0.34 to 0.49 and super-cavitation with coherent water jet surrounded by vapor volume appeared when the cavitation numbers reached 0.17 to 0.28. As a comparison, if a submerged water column generator 130 had its turbine generator assembly 610 at a depth of 500.0′ from the surface 170, then its K value would be K=445 which essentially would mean there would be no chance of cavitation.

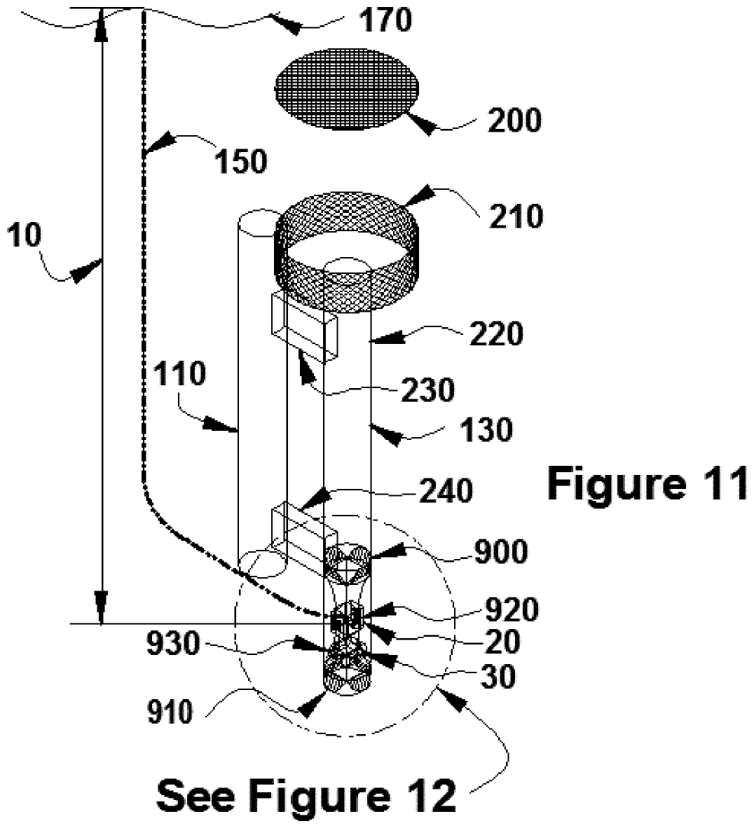

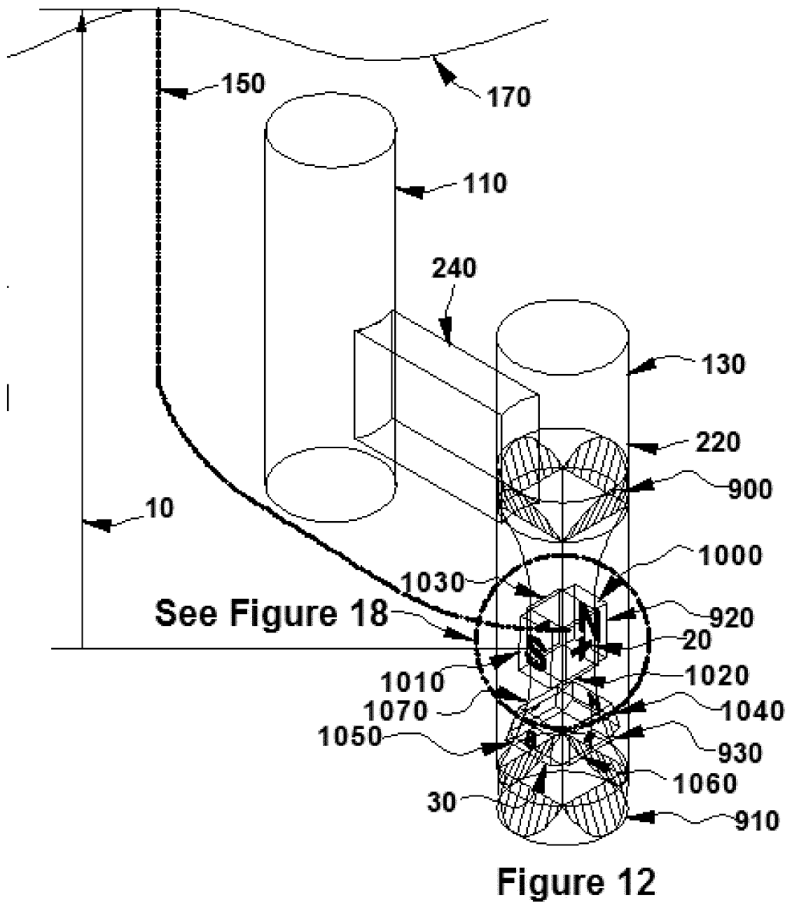

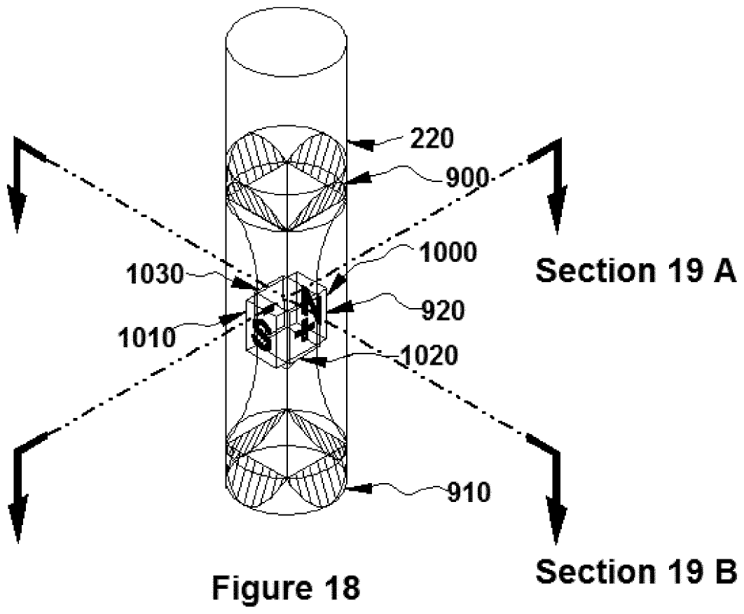

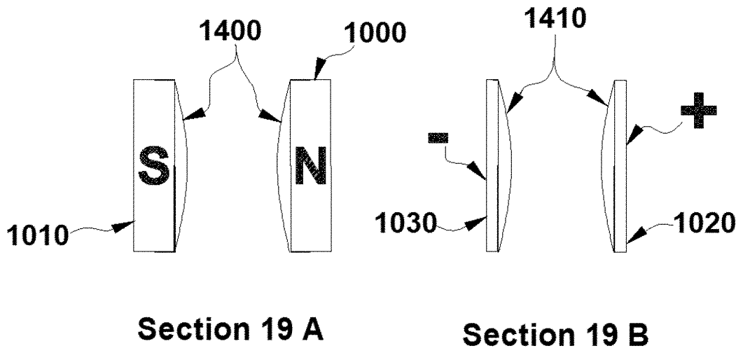

FIG. 11 shows another submerged water column generator design 130 which could be placed at a lower depth from the surface 170 and this could also increase the PE 10. This embodiment may present an additional challenge with sealing the turbine generator design 250 and 610, so a magnetohydrodynamic (MHD) generator assembly 920 could be employed instead. There are no moving parts with a magnetohydrodynamic (MHD) generator assembly 920 so this method may be employed at lower depths. This particular submerged water column generator design 130 could have similar components such as the filtration system 200 and 210, along with the Water Column 220 and the mounting structures 230 & 240 which are attached to both the foundation structure 110 and the Water Column 220. This design may also have a round to square transition pipe 900 to lead into the magnetohydrodynamic (MHD) generator assembly 920. The flow would then enter the expanding square to round transition pipe 910 and the water flow would go out into the surrounding water. To initiate the flow the previous designs that employed a lower evacuation pump assembly 260 which consisted of some turbine pumps 340 in a lower chamber 330; instead a magnetohydrodynamic (MHD) propulsion assembly 930 could be employed at the base of the Water Column 220 and possibly in the expanding square to round transition pipe 910, to pump the lower water volumes out of the base of the submerged water column generator 130. The KE 20 would be tapped by the magnetohydrodynamic (MHD) generator assembly 920 and the AE 30 would be supplied by magnetohydrodynamic (MHD) propulsion assembly 930. To transmit the power from the magnetohydrodynamic (MHD) generator assembly 920 to the surface 170 and the upper platform 100 a deep depth power cable 150 would be needed. Of course, with any design, there are performance characteristics that need to be addressed and with a magnetohydrodynamic (MHD) generator assembly 920 and a magnetohydrodynamic (MHD) propulsion assembly 930, there can be the accumulation of minerals on the inner flow services that are in close proximity to both MHD assemblies 920 and 930. This calcification would need to be cleared periodically, so this behavior would need to be addressed (see FIGS. 12 and 18). Also, the power coming from the MHD generator assembly 920 may be DC current, so it would need to be converted into AC on the upper platform 100.

FIG. 12 shows a close up view of an embodiment of the submerged water column generator design 130 where a magnetohydrodynamic (MHD) generator assembly 920 is shown. The water column generator 130 would be mounted to the foundation structure 110 by the mounting structure 240. Again, there is the Water Column 220 along with the upper flow transition pipe from round to rectangular 900 and the lower flow transition pipe from rectangular to round 910. The magnetohydrodynamic (MHD) generator assembly 920 consists of: magnet with the north pole facing out 1000 and a apposing magnet with the south pole facing outward 1010. Ninety degrees to the magnets would be an anode supplying a positive connection to the generator 1020 and a cathode supplying negative connection to the generator 1030. The electrical current that would be delivered would be DC and not AC. To initiate the water flow in the submerged water column generator 130 would be a similar magnetohydrodynamic (MHD) design but it would be designed to imitate flow and not tap the energy from that flow. Since the energy required would be less for the magnetohydrodynamic (MHD) propulsion assembly design 930, many of the parts would be smaller but similar to the magnetohydrodynamic (MHD) generator assembly design 920. So there would be a magnet with the north pole facing outward 1040 and a opposing magnet with the south pole facing outward 1050 and at ninety degrees to the magnets would be an anode supplying a positive connection to the generator 1060 and a cathode supplying negative connection to the generator 1070. Again the performance for the magnetohydrodynamic (MHD) propulsion assembly design 930 would be to force the lower water volumes out of the base of the Water Column 220, so that the freefalling water now in the Water Column 220 could generate power in the magnetohydrodynamic (MHD) generator assembly 920. Once again, the PE 10 from the water surface 170 to the magnetohydrodynamic (MHD) generator assembly 920 provides KE 20 and to initiate that freefall flow the magnetohydrodynamic (MHD) propulsion assembly design 930 needs to provide the AE 30. The DC power would be transmitted from the magnetohydrodynamic (MHD) generator assembly 920 to the surface upper platform 100 with the deep depth power cable 150. Some calcification can build up with the Magnetohydrodynamic (MHD) generator assembly 920 and the Magnetohydrodynamic (MHD) propulsion assembly design 930 so a possible method to address this problem is discussed in FIG. 18, FIG. 19A and FIG. 19B.

A possible method for power generation will be the elimination of turbine blades and spinning generators by replacing these structures with magnetohydrodynamic (MHD) Generators. There has already been some research into propelling ships with MHD thruster systems but to date there are no known MHD power generators being deployed. Such systems have no moving parts but instead use electrical and magnetic forces, to make charged water flow through an electromagnetic field. But there are some problems with some deposit buildups of various compounds such as calcium hydroxide and magnesium hydroxide. These deposits are insulators and may drop the efficiency of the Magnetohydrodynamic generator or pump by 12% in just a few days, so different materials and cleaning methods will be needed for a production model design. One possible way to eliminate the calcification would be to have fluid filled bladders that could be inflated to remove the calcification. Such bladders would be analogous to the deicing bladders on some aircraft wings. These bladders would be attached to the magnetic surfaces and the anode and cathode surfaces and they would be activated periodically to remove the calcification buildup. Also, the water needs to be conductive, as with seawater and the efficiencies may not be as high as a turbine generator assembly, but because there are no moving parts and the fact that such systems may be operated at deeper depths, MHD systems may be a viable design type for some submerged water column generator designs.

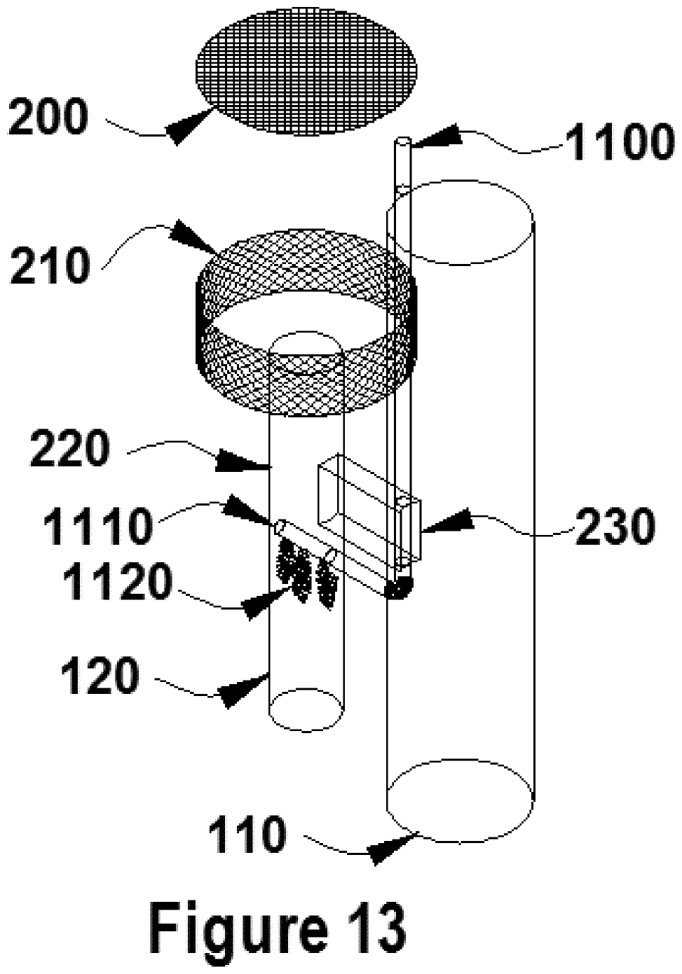

Turning to FIG. 13, this figure is not related to producing power but it could be another “green” or improved environmental feature that could be added to a submerged water column generator 120. Many parts of the world's oceans are lacking full oxygen levels. Some theories attribute these oxygen declines to increase ultraviolet radiation coming from the sun, due to the fact that the sun is going through a solar minimum and these large ultraviolet radiation levels adversely affects plankton growth. Of course, manmade pollutants also affect plankton growth and because of these lower plankton growth levels, less oxygen is delivered to the world's oceans. There are other natural ways that oxygen gets into the ocean, such as wave turbulence and fresh water runoff but again the reduce plankton growth does have a substantial impact on the oxygen levels of the world's oceans and this result in there being fish died off zones. Many of these died off zones are at lower depths in the world's oceans and they can cover large areas. Because large volumes of water would be channeled through submerged water column generators 120 and that water would need to be filtered by the upper and circumferential flow filters 200 and 210; that cleaned water will also have a positive impact on the environment. But in addition to filtering the water through the upper and circumferential flow filters 200 and 210, the quality of the water could also be improved by oxygenating it with a compressed air pipe 1100. The compressed air would be released through ports in the air pipe 1110. The amount of compressed air 1120 would not be too extreme but instead may only take 1% or less of the power produced by the submerged water column generator 120. The volume of compress air 1120 would need to be low enough, so that the air would be completely dissolved in the water column 220 before reaching any of the turbine power assembly 250 or the lower evacuation pump assembly 260. The compressed air pipe 1100 and the submerged water column generator 120 would be attached to the foundation structure for the oil platform 110. From calculations of the water flow rates from a submerged water column generator 120, the amount of water that would be released in 600 days, would be 1.0 cubic mile and that submerged water column generator 120 would produce 105 MW of power. So the oxygenation of ocean water could be substantial over time if a large number submerged water column generators 120 where deployed.

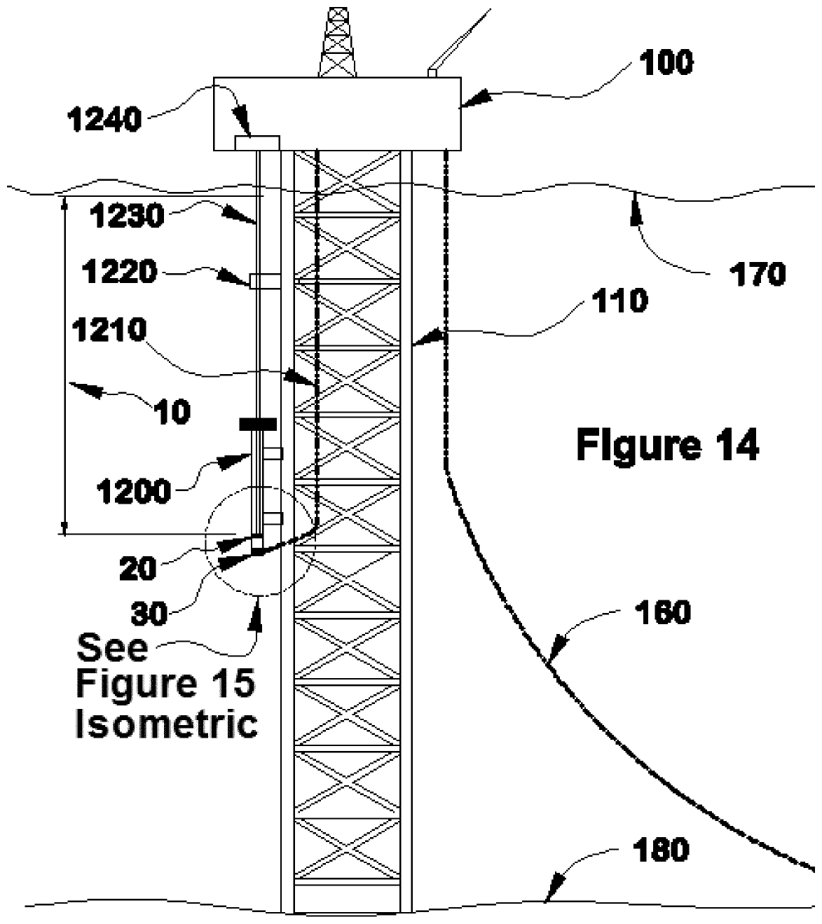

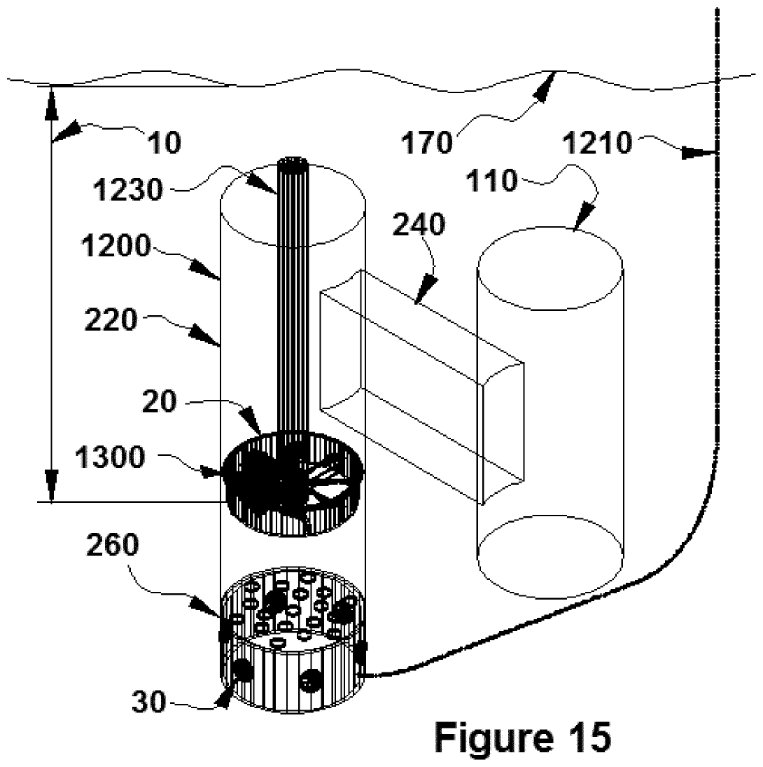

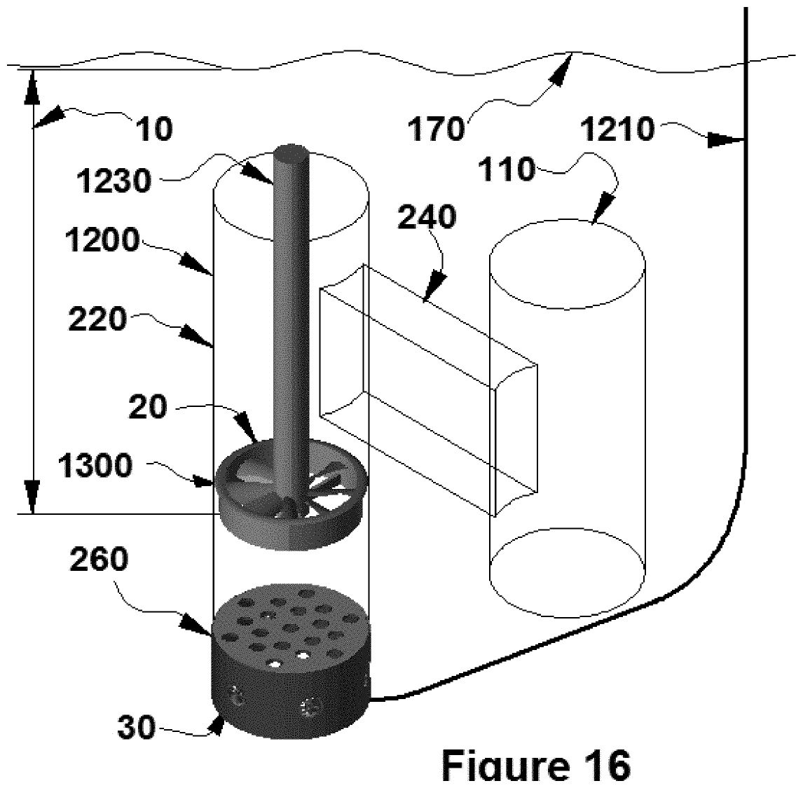

FIG. 14 is similar to FIG. 2, but instead of getting electrical power from the submerged water column generators 120 and 130 in the form of a turbine generator 250 or a Magnetohydrodynamic (MHD) Generator 920 this submerged water column generator with driveshaft 1200 would have a topside mounted generator 1240 set in the oil well platform 100 so that the generator would not be submerged in water. This submerged water column generator with driveshaft 1200 design would have its turbine blade assembly 1300 (see FIG. 15) mounted it the Water Column 220 (see FIG. 15) but the topside mounted generator 1240 would be set in the oil well platform 100. The topside mounted generator 1240 would be attached to turbine blade assembly 1300 by a driveshaft 1230 and that driveshaft 1230 would have support bearing mounts 1220 as needed to prevent uncontrolled side displacements of the driveshaft 1230. Again, the advantage of this design is to prevent generator 1240 from being submerged. Once again this submerged water column generator with driveshaft 1200 design could be installed in active or retired oil well platforms 100 and some of the submerged water column generator with driveshaft 1200 would be set in the top section of the oil well platform 100, such as the topside mounted generator 1240, and the other hardware, such as the driveshaft 1230 the support bearing mounts 1220 and the lower section of the submerged water column generator with driveshaft 1200 would be mounted to the lower support structure 110. The Potential Energy 10 would be directly related to the depth from the surface 170 to the turbine blade assembly 1300 and that Potential Energy 10 would be turned into Kinetic Energy 20 by employing Activation Energy 30 which would be the removal of the water at the base of the submerged water column generator with driveshaft 1200. In this design the Activation Energy 30 would be through the use of a lower evacuation pump assembly 260 (see FIG. 15) which would be powered from the upper oil well platform to evacuation pumps power cable 1210. The power generated by the topside mounted generator 1240 would be sent through the power cable from the platform to the land power grid 160 along the ocean floor 180.

FIG. 15 shows the lower section of a submerged water column generator with driveshaft 1200. In this design a driveshaft 1230 is attached to turbine blade assembly 1300 and at the top of oil well platform 100 (see FIG. 14) the driveshaft 1230 would also be attached to the topside mounted generator 1240 (see FIG. 14). The only other difference is the power cable for the evacuation pumps 1210. It should be noted that mechanical evacuation pumps could also have a drive shaft to the top of the oil well platform 100 or even a mechanical power take off from the main driveshaft 1230, so this design layout is not necessarily a final design. This submerged water column generator with driveshaft 1200 utilizes the same general operating principles, in that there is PE 10 which is converted into KE 20 by employing AE 30. The AE 30 is supplied by the evacuation assembly 260 and this starts the freefall of the water in the Water Column 220 and that flowing water is now providing KE 20 and that KE 20 can be tapped with the turbine blade assembly 1300 which is attached to the driveshaft 1230. The whole submerged water column generator with driveshaft 1200 assembly is attached to the oil platform structure 110 by one of the mounting structures 240. The driveshaft 1230 is attached to topside mounted generator 1240 which produces electrical power and is mounted inside the top section of oil well platform 100. Again, in this design the topside mounted generator 1240 is above the lake or ocean surface 170.

FIG. 16 has similar structures as FIG. 15 but some of the structures are surfaced to better display their potential construction. The driveshaft 1230 and the turbine blade assembly 1300 are both surfaced, along with the shows the lower section of a submerged water column generator with evacuation assembly 260. All of the other components have a similar layout as FIG. 15.

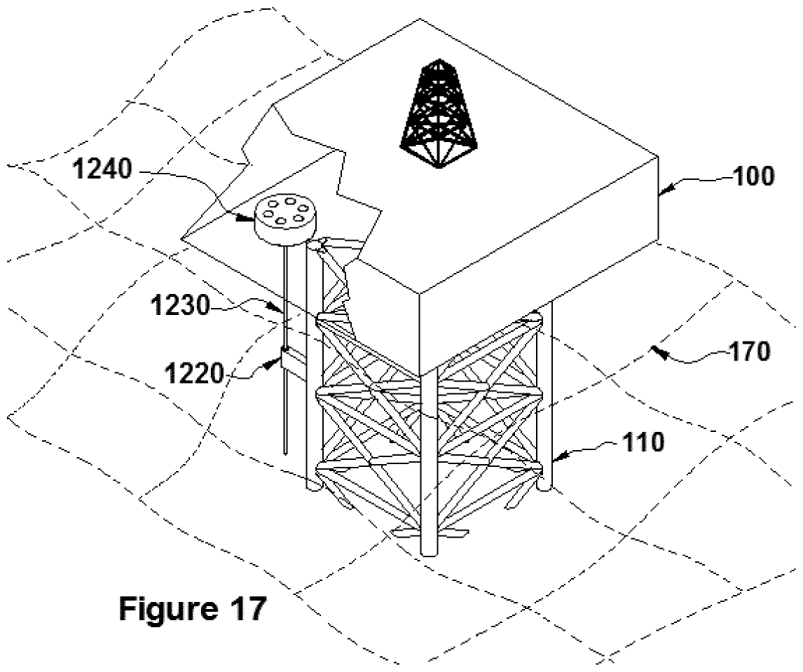

FIG. 17 gives a basic isometric view of a top section of a submerged water column generator with driveshaft 1200 (low section not shown). The Topside Mounted Generator 1240 is shown mounted inside of the oil well platform 100 and the driveshaft 1230 is shown going through one of the support bearing mounts 1220. The driveshaft 1230 continues on down to the turbine blade assembly 1300 which is mounted in the Water Column 220. The driveshaft 1230 goes below the ocean surface 170 and the whole submerged water column generator with driveshaft 1200 assembly is attached to the top section of oil well platform 100 and the platform structure 110.

FIG. 18 is an isometric view of a Magnetohydrodynamic (MHD) generator assembly 920 but without the Magnetohydrodynamic (MHD) propulsion assembly design 930 being shown as in FIG. 12, since both Magnetohydrodynamic (MHD) systems have similar construction. Also, the inflatable water bladders 1300 and 1310 are not shown because it would be difficult to show the structures of these systems in an isometric view so they are only discussed in FIG. 19 A and FIG. 19 B. This isometric view is being used to show were the crosscut section 19 A and 19 B are taken from. So, there is still the Water Column 220 the upper flow transition pipe from round to rectangular 900 and the lower flow transition pipe from rectangular to round 910. The Magnetohydrodynamic (MHD) generator assembly 920 consists of magnet with the north pole facing out 1000 and a apposing magnet with the south pole facing outward 1010. Ninety degrees to the magnets would be an anode supplying a positive connection to the generator 1020 and a cathode supplying negative connection to the generator 1030.

FIG. 19 A and FIG. 19 B shows the potential layout of inflatable water bladders 1400 which would be attached to the magnet part of generator assembly with north pole facing outward 1000 and the magnet part of generator assembly with south pole facing outward 1010. These inflatable water bladders 1400 would be used periodically to decalcify mineral layers that accumulate on Magnetohydrodynamic (MHD) systems. The similar inflatable water bladder 1410 system would be used on the anode (+) connected to positive power source 1020 and the cathode (−) connected to negative power source 1030. These inflatable bladders 1400 and 1410 are similar to aircraft deicers on the leading edge of wings to breakaway ice accumulations. The inflatable water bladders 1400 and 1410 can be used periodically to breakaway the calcification layers that can accumulate on the inner flow surfaces on the Magnetohydrodynamic (MHD) generator assembly 920 and the Magnetohydrodynamic (MHD) propulsion assembly design 930. Note section cuts for the Magnetohydrodynamic (MHD) propulsion assembly design 930 are not shown but they would be similar in their design and construction to the inflatable bladders 1400 and 1410 to clear away the calcification layers.

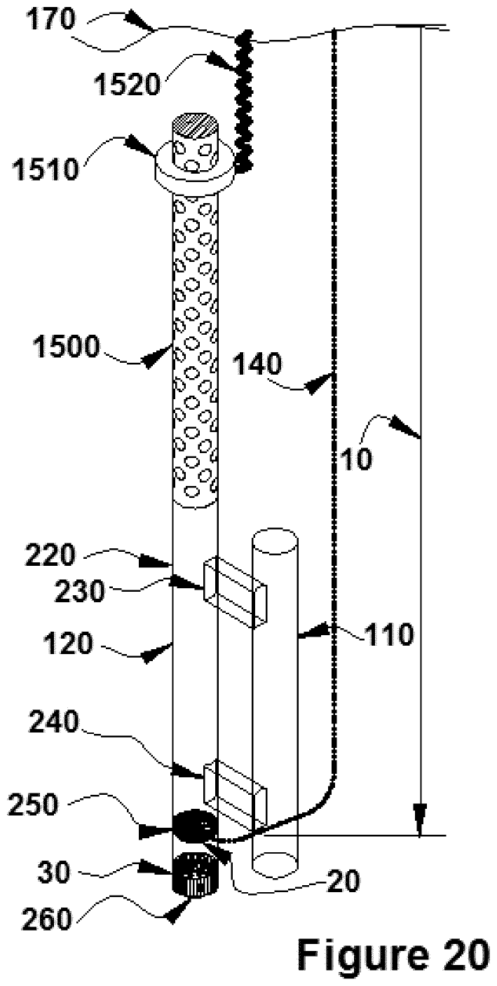

FIG. 20 has many of the same components as in FIG. 3, such as the submerged water column generator design 120. Also, the KE 20 would be turned into electrical power with a turbine generator 250. Again, the available KE 20 would be determined by the placement depth and the resulting PE 10. This design adds an upper Water Column with entry ports and filtration screening 1500 to prevent the generator assembly 120 from drawing in sea life or manmade and natural debris. The staggered hole pattern will distribute the flow entry points over a larger area, thereby reducing the likelihood of vortex formation. Also, a vacuum flow pump cleaner could be added to clear the flow porting of debris and that debris could be pumped to the surface 170 through the flexible Water Column to surface sorter 1520 where the sea life can be returned and the plastic waste removed. The Water Column 220 would be designed to an optimal wall thickness and length after computer modeling. There may also be mounting structures 230 and 240 so that the submerged water column generators 120 could be attached to the oil well platform structure 110. At the base of the Water Column 220 is the evacuation assembly 260 which act as the AE 30 to remove the water layer from the lower section of the Water Column 220 so that the water in the Water Column 220 can go into freefall. The PE 10 is the distance between the water surface 170 and the generator assembly 250 and that PE 10 can be converted into KE 20 and then electrical energy with the generator assembly 250. The water flow can be initiated by pumping the lower water volumes 260 out of the lower section of the Water Column 220; this is a form of AE 30. The power generated by the generator assembly 250 would be transferred to the upper platform 100 by the moderate depth power cable 140.

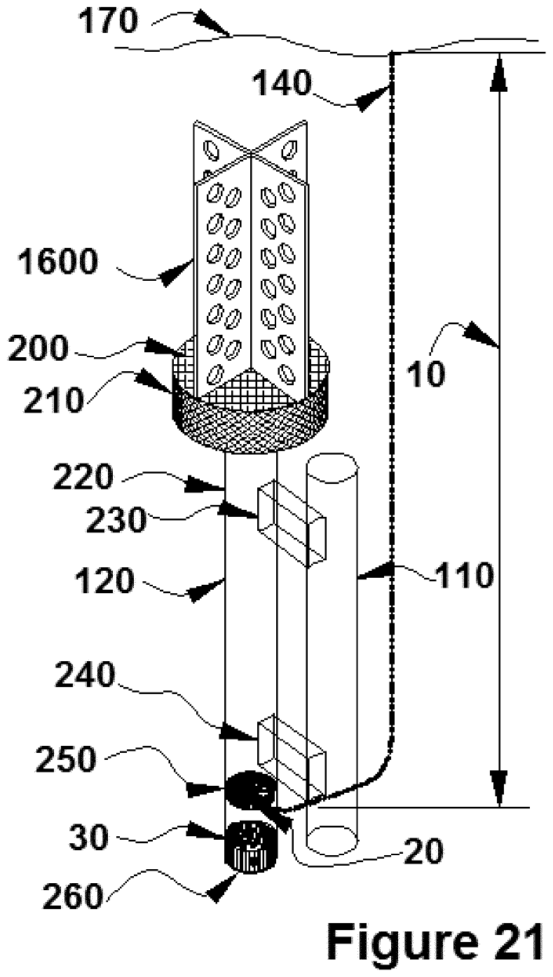

Turning to FIG. 21, this embodiment has many of the same components as FIG. 3 of the submerged water column generator design 120. In this design, the KE 20 would be turned into electrical power with a turbine generator 250. Again the available KE 20 would be determined by the placement depth and the resulting PE 10. This design also shows a potential filtration system 200 & 210 to prevent the generator assembly 120 from drawing in sea life or manmade and natural debris. Also in this design there is a perforated flow vectoring wall 1600 that would be mounted above the filtration system 200 &210. The perforated flow vectoring 1600 wall would be used to mitigate any venturi formation. The Water Column 220 would be designed to an optimal wall thickness and length after computer modeling. There will also be mounting structures 230 & 240 so that the submerged water column generators 120 could be attached to the oil well platform structure 110. At the base of the Water Column 220 is the evacuation assembly 260 which act as the AE 30 to remove the water layer from the lower section of the Water Column 220 so that the water in the Water Column 220 can go into freefall. The PE 10 is the distance between the water surface 170 and the generator assembly 250 and that PE 10 can be converted into KE 20 and then electrical energy with the generator assembly 250. The water flow can be initiated by pumping the lower water volumes 260 out of the lower section of the Water Column 220; this is a form of AE 30. The power generated by the generator assembly 250 would be transferred to the upper platform 100 by the moderate depth power cable 140.

The sample calculations below show the power output of a potential submerged water column generator design. These calculations are one potential way to analyze the system for illustrative purposes, and are not intended to be limiting of the scope of this invention. There are many possible embodiments and ways to analyze this system. In the analysis of this embodiment, the Potential Energy (PE) is converted to Kinetic Energy (KE) by getting the water to go into freefall by removing the lower support volume of water from the base of the water column. The energy needed to remove the water from the base is known as the Activation Energy (AE). This calculation will show that the KE, even with loses, is many hundreds of time greater than the AE. But initially the following equation should be considered on how a standard hydroelectric dam operates with just the freefall of a water column, with little blockage at the base of the flow pipe. Therefore, the water outflow at the base of the flow pipe will not be submerged in a deep body of water

The following equation shows how the power for a hydroelectric dam is derived from Bernoulli's Equation.

Bernoulli's Equation

P₁+½(ro)V²₁+(ro)gh₁=P₂+½ (ro)V²₂+(ro)gh₂

P—Is the work done by pressure per unit volume

½(ro)v²—Is the Kinetic Energy (KE) per unit volume

ρgh₁—Is the Potential Energy (PE) per unit volume

Station #1 is located at the surface of the body of water

Station #2 is located at the level of the hydroturbine and water exit

P₁=0

V₁=V₂

½ (ro)V²₁=½ (ro)V²₂

h₁=500 h₂=0

(ro)gh₂=0

P₂=(ro)gh₁

Power=Force×Velocity=Pressure×Mass Flow

Mass Flow=Q=Area Pipe×Velocity=A V

Power=(ro)g h₁ A V₁

V₁=g t₁

h₁=½ g t²₁

t₁=((2)(h₁)/g)^{1/2}

V₁=g((2)(h₁)/g)^{1/2}

V₁=((2)(h₁)(g))^{1/2}

Power=(ro)g h₁ A V₁=(ro)gh₁ A ((2)(h₁)(g))^{1/2}

Power=(2)^{1/2}(ro)A ((h₁)(g))^{3/2}

Q=A (2 g h₁)^{1/2}

Power=(ro)Q g h₁ no losses considered

Now consider the similar example of a hydroelectric dam equation but instead of the water flowing out of the base of the dam, with little flow impedance, other than the normal losses; this water column is totally submerged. Therefore, to initiate the flow of the water column, the lower volumes of water at the base of the water column, need to be removed so that the upper volumes of water will freefall. Note the following calculations are just using sample numbers, such as turbine and generator efficiencies, flow tube diameters and drop heights, therefore these variables are by no means set numbers. In this example, the following assumptions are made; the efficiency of the turbine and generator assembly is (eta)=0.85; the inner radius of the water column is r=2.25′; the water column has a 300.0′ length; the exit point of the water column is h=500.0′; and the water pump height is H=1.0′. The results of this one possible analysis is given below:

Available Power=Power from Freefall−Power for Evacuation Pump

Available Power=P_{Total}=P_{freefall}−Pₚᵤₘₚ

P_{freefall}=(eta)(ro)Q g h (ft-lbs/sec)

Pₚᵤₘₚ=QH/3960(Horse Power) (Q−gal/min, H−pump height in ft)

448.831 gal/min=1.0 ft³/sec

HP=550 ft-lbs/sec

Pₚᵤₘₚ=QH/3960 HP=(550)(448.831)(Q)(H)/3960 ft-lbs/sec

Pₚᵤₘₚ=(62.33)QH ft-lbs/sec

P_{Total}=P_{freefall}−Pₚᵤₘₚ=((eta)(ro)Q g h) ft-lbs/sec)−(62.33)(Q H) ft-lbs/sec

(ro)=w/((Vol) g) (water density)

(ro)=(64.0 lbs/ft³)/32.16 ft/sec²=1.99 slugs/ft³ mass (water density)

(eta)=0.85 (turbine/generator efficiency)

A_{c}=_(2.25)²=15.9 ft² (flow area)

g=32.16 ft/sec² (acceleration of gravity)

h=500.0′ (depth of pipe exit)

Q=Ac (2 g h)^{1/2} (water flow rate from freefall)

Q=15.9 ft² ((2) (32.16 ft/sec²) (500 ft))^{1/2}=2,851 ft³/sec (water flow rate from freefall)

P_{Total}=((eta)(ro)Q g h−(62.33)QH) ft-lbs/sec (total power output)

P_{Total}=(0.85) (1.99) (15.9((2) (32.16) (500))^{1/2}) (32.16) (500)ft-lbs/sec−((62.33 (15.9((2) (32.16) (500))^{1/2})(1)ft-lbs/sec

P_{Total}=77,555,605.1 ft-lbs/sec−177,726.5 ft-lbs/sec=77,377,856.8 ft-lbs/sec

So, for this particular example the amount of power generated was 436 times greater than the power required to initiate it. Note: There are 737,562.15 ft-lbsf/s per 1 MW. Here, P_{Total}=105 MW and about 0.24 MW to power the pumps or a 323 HP pump to generate 105 MW of electricity.

Two more sample calculations follow using the instillation depths shown in FIG. 2 all of the other parameters are the same except the diameter of the Water Column or water column 220 which is 10.0′ not 4.5′ as in the previous calculation. Again, these calculations are another possible way to analyze the system and are non-limiting on this disclosure. In FIG. 2, the power generated by submerged water column generator 120 has its hydro turbine power assembly 250 at a 400.0′ depth and its Water Column 220 has a 100.0′ length and a 10.0′ diameter. So it is P_{freefall}=371.6 MW minus the Activation Energy (AE)=1.06 MW; giving a Total Power Output=P_{Total}=370.5 MW. The other submerged water column generator 130 also has some form of hydro turbine power assembly 250 but its depth is at 800.0′. It has the same Water Column 220 length that being 100.0′ and the same 10.0′ diameter. Because of the deeper depth, the potential power output is greater so P_{freefall}=1,051.2 MW minus the Activation Energy (AE)=1.51 MW; giving a Total Power Output=P_{Total}=1,049.7 MW.

These sample calculations show the potential power output from these relatively small submerged water column generators 120 can be substantial and their overall build and operation costs would be very low when compared to existing technologies employed in electric power generation.

In another embodiment of the system, the system may be placed at a depth under the surface of a body of water, for example at a deep depth under the surface of the ocean. This may have advantageous effects, such as increased power output. In addition, the deeper depths may decrease cavitation occurring in the system, and in particular, cavitation occurring at the venturi surface in the inside of the flow column near the fluid turbine. Also the chances of cavitation formation on the moving turbine blades can also be reduce when a turbine is set at deeper depths. As a non-limiting example, a depth of approximately 500 or 5000 feet may be a sufficient depth to observe decreased cavitation at the venturi. To achieve these depths, it may be advantageous to control fluid flow into the inlet with a inlet control valve that can eliminate fluid flow to stop and start the system. In addition, in any of the above embodiments, fluid flow control valves may be generally integrated into the system, at any location in the fluid flow column, to control, to stop or start, or to increase or decrease, flow through the system. This can be accomplished with any suitable fluid valve known in the art.

In yet another embodiment of the system, the pumps could pump the water upwards to the top of the fluid column, for re-entry into the inlet of the system. In any of these analyses, the distance from the inlet to the fluid power generator, and the distance from the distance from the fluid power generator to the pump system, can each be designed for optimum performance. That is, these distances may be modified to increase the power put into the fluid power generation system, or to decrease the amount of fluid that may be sent to the pumps before all of the fluid may be expelled and the system runs its cycle over again. The present invention can be designed variously in this regard to achieve better performance or more optimum efficiency.

Any combination of the above features and options could be combined into a wide variety of embodiments. It is, therefore, apparent that there is provided in accordance with the present disclosure, systems and methods for designing and implementing a water column power generation system. While this invention has been described in conjunction with a number of embodiments, it is evident that many alternatives, modifications, and variations would be, or are apparent to, those of ordinary skill in the applicable arts. Accordingly, applicants intend to embrace all such alternatives, modifications, equivalents and variations that are within the spirit and scope of this invention.

I claim:

1. A power generation system, comprising:
a hollow fluid flow column, substantially parallel with the direction of gravitational acceleration,
a fluid inlet at one end of said hollow fluid flow column,
at least one fluid power generator located in said hollow fluid flow column at a distance from said fluid inlet,
at least one pump located in fluid communication with said hollow fluid flow column at a distance further from said fluid inlet than said fluid power generator,
fluid outlets located in said hollow fluid flow column, that allow said at least one pump to pump a fluid out of said hollow fluid flow column after it has flowed past said fluid power generator, and
an electrical distribution cable in communication with said fluid power generator and said at least one pump.

2. The system of claim 1, wherein said at least one fluid power generator is a fluid turbine.

3. The system of claim 2, further comprising a driveshaft and an electric generator, wherein said driveshaft is attached to said fluid turbine, and wherein said driveshaft drives said electric generator.

4. The system of claim 1, wherein said at least one fluid power generator is a magnetohydrodynamic generator.

5. The system of claim 4, wherein said at least one pump is a magnetohydrodynamic fluid propulsion system.

6. The system of claim 1, further comprising at least one fluid pump near said fluid inlet.

7. The system of claim 1, further comprising a valve at the fluid inlet to control fluid inlet into said hollow fluid flow column.

8. The system of claim 7, further comprising a controller operable to actuate said valve, operable to activate said fluid power generator, operable to activate said at least one pump, and operable to regulate energy storage in the at least one battery.

9. The system of claim 1, further comprising a venturi in said hollow fluid flow column at the location of said at least one fluid power generator, wherein said power generation system is submerged beneath the surface of a body of water at a depth sufficient to decrease cavitation in said venturi section.

10. The system of claim 1, wherein said at least one pump evacuates a fluid from said hollow fluid flow through said fluid outlets in said hollow fluid flow column, wherein the direction of fluid flow through said fluid outlets is radial or axial.

11. The system of claim 6, wherein said at least one fluid pump near said fluid inlet pumps fluid from outside of said hollow fluid flow column into said hollow fluid flow column towards said fluid power generator.

12. The system of claim 1, further comprising a fluid filter in said hollow fluid flow column.

13. The system of claim 1, further comprising an oxygenation system in said hollow fluid flow column.

14. A submerged power generation system, the system comprising:
a fluid column,
a fluid inlet at one end of said fluid column,
a fluid outlet at the other end of said column,
a pump system inside said column,
a fluid electrical power generation system inside said column,
a power distribution and storage system connected to said fluid electrical power generation system, and
a controller operable to activate said fluid electrical power generation system, operable to activate said pump system, and operable to control said power distribution and storage system.

15. A method of power generation, the method comprising the steps of:
positioning a hollow fluid flow column such that it is substantially parallel to the direction of gravity,
permitting a volume of fluid to flow into the inlet of said hollow fluid flow column,
flowing said volume of fluid past at least one fluid power generator in said hollow fluid flow column, and
pumping said volume of fluid out of said hollow fluid flow column after it flows past said at least one fluid power generator.

16. The method of claim 15, further comprising the step of pumping said volume of fluid into said hollow fluid flow column from a surrounding body of water.

17. The method of claim 15, further comprising the step of distributing electrical power generated by said fluid through said fluid power generator to a power network.

18. The method of claim 17, further comprising the step of managing the power generation, pumping, and power distribution functions of the power generation system with a controller.

19. The method of claim 18, further comprising the steps of:
filtering the water flowing through the power generation system, and
oxygenating the water flowing through the power generation system.

20. The method of claim 19, further comprising the step of placing said fluid flow column at a depth submerged beneath the surface of a body of water.
